(19) United States
(12) Patent Application Publication
(10) Pub. No.: US 2016/0195655 A1
(43) Pub. Date: Jul. 7, 2016

(54) POLARIZING PLATE FABRICATION METHOD

(71) Applicant: FUJIFILM Corporation, Tokyo (JP)

(72) Inventors: Hideaki KAGAWA, Kanagawa (JP); Kazuhiro OKI, Kanagawa (JP)

(73) Assignee: FUJIFILM Corporation, Tokyo (JP)

(21) Appl. No.: 15/069,307

(22) Filed: Mar. 14, 2016

Related U.S. Application Data
(63) Continuation of application No. PCT/JP2014/075561, filed on Sep. 26, 2014.

(30) Foreign Application Priority Data
Sep. 27, 2013 (JP) 2013-201540

(51) Int. Cl. G02B 5/30

(52) U.S. Cl. CPC G02B 5/3016; G02B 5/305; G02B 5/3083

(57) ABSTRACT

The polarizing plate fabrication method includes the following: (1) preparing a transfer material including a temporary support and a transfer body including an optical anisotropic layer and an optical anisotropic layer; (2) peeling the temporary support and separating it from the transfer body; and (3) adhering the transfer body to a film including a polarizer, in which both the optical anisotropic layer and the optical anisotropic layer are layers formed of a polymerizable composition including a liquid crystal compound applied onto the temporary support, and the optical anisotropic layer and the optical anisotropic layer both have in-plane retardation, and a difference between slow axis directions in the optical anisotropic layer and the optical anisotropic layer is in a range of 3° to 90°. The fabrication method allows adhering of an optical anisotropic layer having a variety of optical compensation capabilities to a variety of polarizers in a minimum constitution.

### CROSS-REFERENCE TO RELATED APPLICATIONS

This application is a continuation of PCT International Application No. PCT/JP2014/075561 filed on Sep. 26, 2014, which claims priority under 35 U.S.C §119 (a) to Japanese Patent Application No. 2013-201540 filed on Sep. 27, 2013, the entire content of which is incorporated herein by reference.

### BACKGROUND OF THE INVENTION

1. Field of the Invention

The present invention relates to a polarizing plate fabrication method. The present invention particularly relates to a fabrication method of a, polarizing plate including an optical anisotropic layer formed of a composition including a liquid crystal compound.

2. Description of the Related Art

In response to the broadening market of smartphones or tablet PCs, there is a gradual demand for thickness reduction in displays. Along this trend, even for retardation films used for view angle compensation in liquid crystal display devices, there is a demand for thickness reduction. Although a number of examples are known in which a film having a predetermined phase difference is used as a protective film for a polarizing plate and the phase difference is realized by means of aligning of a liquid crystal compound (for example, JP2013-050572A and JP2011-133549A), an optical anisotropic layer formed by means of photocuring or the like of a composition including a liquid crystal compound has a low self-supporting property, and thus it is usual for the optical anisotropic layer to be used in a state of being formed on a transparent support such as a cellulose acylate based polymer film, which creates the necessity for studies regarding the thickness reduction of the optical anisotropic layer formed on a support. Meanwhile, JP2004-53770A discloses a thin polarizing plate realized by directly applying a composition including a liquid crystal compound to the surface of a polarizing film so as to form an optical anisotropic layer. In addition, JP2008-242420A describes that an optical anisotropic film made up of an alignment layer and a liquid crystal compensation layer formed on the surface of a supporting member is laminated on a polarizing film so that the alignment layer comes into contact with one surface of the polarizing film while being peeled off from the supporting member.

### SUMMARY OF THE INVENTION

An object of the present invention is to provide a polarizing plate having a small film thickness. Particularly, the object of the present invention is to provide a fabrication method of a polarizing plate including an optical anisotropic layer formed of a composition including a liquid crystal compound in which an optical anisotropic layer having a variety of optical compensation capabilities can be adhered to a variety of polarizers in a minimum constitution.

In order to achieve the above-described object, the present inventors attempted to transfer an alignment layer and an optical anisotropic layer formed by means of photocuring of a composition including a liquid crystal compound on a temporary support to a polarizing film in the same manner as the method described in JP2008-242420A. As a result, while the optical anisotropic layer could be separated from the temporary support together with the alignment layer, the present inventors found a new problem of defect such as cracking being easily generated. The present inventors repeated additional studies on the basis of this new problem and completed the present invention. That is, the present invention provides the following <1> to <14>.

<1> A polarizing plate fabrication method including the following (1) to (3): (1) preparing a transfer material including a temporary support and a transfer body including an optical anisotropic layer 1 and an optical anisotropic layer 2; (2) peeling the temporary support and separating the temporary support and the transfer body; and (3) adhering the transfer body to a film including a polarizer, in which both the optical anisotropic layer 1 and the optical anisotropic layer 2 are layers formed of a polymerizable composition including a liquid crystal compound applied onto the temporary support, and the optical anisotropic layer 1 and the optical anisotropic layer 2 both have in-plane retardation, and a difference between slow axis directions in the optical anisotropic layer 1 and the optical anisotropic layer 2 is in a range of 30 to 90°.

<2> The fabrication method according to <1>, in which the optical anisotropic layer 2 is a layer formed of a polymerizable composition including a liquid crystal compound directly applied to the optical anisotropic layer 1.

<3> The fabrication method according to <1> or <2>, in which the optical anisotropic layer 1 is a layer formed of a polymerizable composition including a liquid crystal compound directly applied to the temporary support.

<4> The fabrication method according to <1> or <2>, in which the optical anisotropic layer 1 is a layer formed of a polymerizable composition including a liquid crystal compound directly applied to an alignment layer on the temporary support.

<5> The fabrication method according to any one of <1> to <4>, including (1), (2), and (3) in this order.

<6> The fabrication method according to <5>, in which the transfer body is adhered to the film including a polarizer on a surface obtained by means of the peeling.

<7> The fabrication method according to any one of <1> to <4>, including (1), (3), and (2) in this order, in which, in (3), the transfer material is adhered to the film including a polarizer on a surface on a transfer body side with respect to the temporary support.

<8> The fabrication method according to any one of <1> to <7>, in which the polarizer in the film including a polarizer is directly adhered to the transfer body.

<9> The fabrication method according to any one of <1> to <8>, in which the polarizer includes modified or unmodified polyvinyl alcohol.

<10> The fabrication method according to any one of <1> to <9>, in which the transfer body and the film including a polarizer are adhered to each other using an adhesive including a modified or unmodified polyvinyl alcohol.

<11> The fabrication method according to any one of <1> to <10>, including between (1) and, (2) and (3): a step of cutting the transfer material to 0.025 m² or smaller.

<12> The fabrication method according to any one of <1> to <11>, in which the temporary support includes a polyester.

<13> The fabrication method according to <12>, in which the temporary support includes polyethylene terephthalate.

<14> The fabrication method according to any one of <1> to <13>, further including: obtaining the transfer material using a method including the following (11) to (14): (11) applying a polymerizable composition including a liquid crystal compound onto the temporary support; (12) obtaining the optical anisotropic layer 1 by means of optical irradiation or heating of a coating layer obtained in (11); (13) applying a polymerizable composition including a liquid crystal compound onto the optical anisotropic layer 1 obtained in (12); and (14) obtaining the optical anisotropic layer 2 by means of optical irradiation or heating of a coating layer obtained in (13).

According to the present invention, a fabrication method of a thin film polarizing plate is provided. According to the fabrication method of the present invention, it is possible to fabricate a polarizing plate by adhering an optical anisotropic layer having a variety of optical compensation capabilities which is formed of a composition including a liquid crystal compound to a variety of polarizers in a minimum constitution.

### BRIEF DESCRIPTION OF THE DRAWINGS

FIG. 1 is a view illustrating examples of the layer constitution of a polarizing plate fabricated using a fabrication method of the present invention.

### DESCRIPTION OF THE PREFERRED EMBODIMENTS

Hereinafter, the present invention will be described in detail.

Meanwhile, in the present specification, “to” used to express numerical ranges will be used with a meaning that numerical values before and after the “to” are included in the numerical ranges as the lower limit value and the upper limit value. In addition, in the present specification, a “slow axis” refers to a direction in which the refractive index reaches the maximum in a plane. In the present specification, a “polarizing plate”, unless particularly otherwise described, refers to both a long polarizing plate and a polarizing plate cut (in the present specification, “punching”, “cutting-out”, and the like are also considered as “cutting”) to be small enough to be combined into a liquid crystal display device. In addition, in the present specification, a “polarizer” (in some cases, also referred to as “polarizing film”) and a “polarizing plate” are distinctively used, and a “polarizing plate” refers to a laminate including a film on at least one surface of a “polarizer”.

In addition, in the present specification, “(meth)acrylates” represent “either or both acrylates and methacrylates”. “(Meth)acrylic acids” also represent “either or both acrylic acids and methacrylic acids”.

In the present specification, Re (λ) represents in-plane retardation at a wavelength of λ. Re (λ) can be measured using a polarization phase difference analyzer AxoScan manufactured by Axometrics, Inc. Alternatively, Re (λ) may be measured by the incidence of light having a wavelength of λ nm in a film normal direction using a KOBRA 21ADH or WR (manufactured by Oji Scientific Instruments).

In the present specification, unless particularly otherwise described, the measurement wavelength is 550 nm. For example, a simple sign of ‘Re’ represents Re (550). In addition, in the present specification, ‘being optically isotropic’ means that the absolute value of in-plane retardation (Re (550)) is 10 nm or smaller. ‘Having in-plane retardation’ means that Re (550) is greater than 10 nm.

In addition, in the present specification, angles (for example, an angle of “90°” or the like) and angular relationships (for example, “orthogonal”, “parallel”, “intersect at 45°” and the like) are considered to include an error range permitted in the technical field to which the present invention belongs. For example, an angle is considered to be in a range of the strict angle±less than 10°, and the error from the strict angle is preferably 5° or less and more preferably 3° or less.

[Polarizing Plate]

A polarizing plate fabricated using a fabrication method of the present invention includes an optical anisotropic layer 1, an optical anisotropic layer 2, and a polarizer. The optical anisotropic layer 1 and the optical anisotropic layer 2 may be disposed on either or both sides of the polarizer. The polarizing plate may further include other layers such as an alignment layer for aligning a liquid crystal compound during formation of the optical anisotropic layer and a protective film for protecting the surface of the polarizer or the optical anisotropic layer.

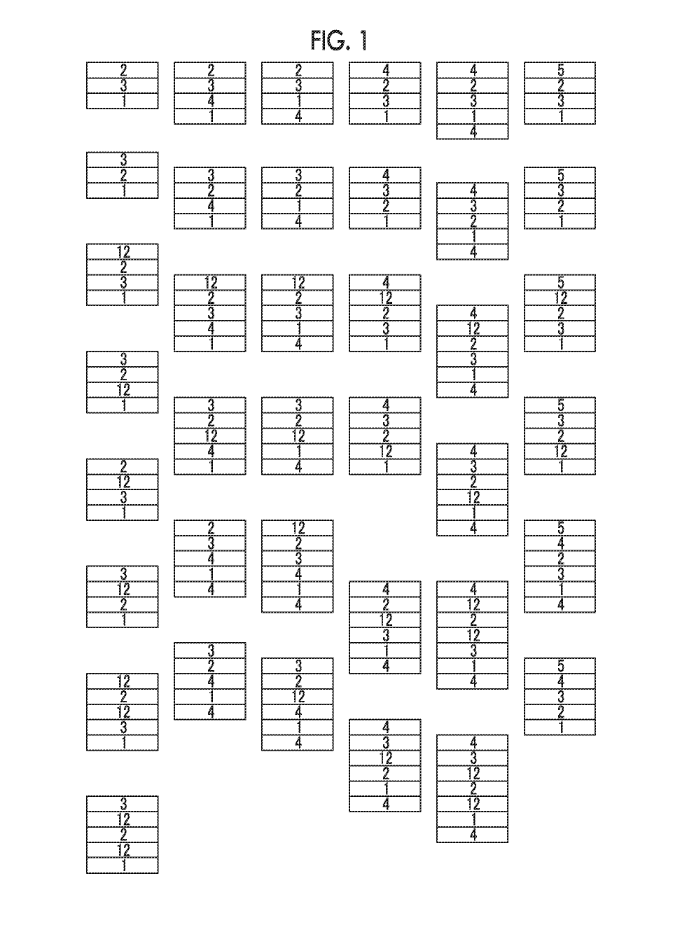

Examples of the layer constitution of the polarizing plate fabricated using the fabrication method of the present invention are illustrated in FIG. 1. Meanwhile, in the drawing, an adhesive layer is not illustrated.

The film thickness of the polarizing plate is not particularly limited and may be in a range of 50 μm to 500 μm. Particularly, according to the fabrication method of the present invention, it is possible to form the polarizing plate having a thin film thickness of 200 μm or smaller, 150 μm or smaller, 120 μm or smaller, 100 μm or smaller, 90 μm or smaller, 80 μm or smaller, 70 μm or smaller, or the like.

[Transfer Material]

In the fabrication method of the present invention, a transfer material including a temporary support and a transfer body including the optical anisotropic layer 1 and the optical anisotropic layer 2 is used. In the fabrication method of the present invention, the optical anisotropic layer 1 and the optical anisotropic layer 2 can be formed irrespective of the kind or properties of the film including a polarizer by means of a step of transferring the transfer body from the transfer material to a film including a polarizer and furthermore, the optical anisotropic layer 1 and the optical anisotropic layer 2 can be formed in a variety of alignment forms of a liquid crystal compound using a variety of liquid crystal compounds. For example, a heating step necessary for the formation of the optical anisotropic layers may affect the properties of the polarizer, but the fabrication method in which the transfer material is used is capable of fabricating the optical anisotropic layers without any influence on the polarizer.

The transfer material is a material capable of providing the transfer body including the optical anisotropic layer 1 and the optical anisotropic layer 2 by peeling the temporary support. In the present specification, the “transfer body” includes a subject to be transferred to the film including a polarizer, that is, a subject which is to be adhered to the film including a polarizer and includes the optical anisotropic layer 1 and the optical anisotropic layer 2.

The transfer material may include other layers such as an alignment layer and an adhesive layer in addition to the temporary support, the optical anisotropic layer 1, and the optical anisotropic layer 2. The transfer material may include other layers such as a release layer and a mold release layer between the temporary support and the optical anisotropic layer 1 and the optical anisotropic layer 2.

The transfer material can be fabricated by forming an optical anisotropic layer by directly applying a polymerizable composition including a liquid crystal compound onto the temporary support and photocuring the obtained coating layer so as to cure the polymerizable composition including a liquid crystal compound. In the present specification, “onto the temporary support” means “directly to the surface of the temporary support” or “directly to the surface of a different layer (which may be a single layer or may be made up of a plurality of layers) provided on the surface of the temporary support”. Examples of the “different layer” include an alignment layer and an optical anisotropic layer formed in advance (for example, the optical anisotropic layer 1).

Hereinafter, individual layers in the polarizing plate or the transfer material will be described in detail.

[Optical Anisotropic Layer]

The optical anisotropic layer is a layer having optical characteristics that are not isotropic. In the present specification, unless particularly otherwise described, the “optical anisotropic layer” refers to both the optical anisotropic layer 1 and the optical anisotropic layer 2. The optical anisotropic layer used in the present invention is a layer formed of a polymerizable composition including a liquid crystal compound. For example, the optical anisotropic layer may be formed by polymerizing a liquid crystal compound by means of optical irradiation or heating of a polymerizable composition including the liquid crystal compound. The polymerizable composition includes a liquid crystal compound having at least one polymerizable group, and the liquid crystal compound needs to be polymerized with the polymerizable group by means of light irradiation or heating. The polymerizable composition is preferably directly applied to the temporary support, the alignment layer, other optical anisotropic layers, and the like. When a coating layer is further dried at room temperature or heated (for example, at 50° C. to 150° C. and preferably at 80° C. to 120° C.), molecules of the liquid crystal compound in the layer can be aligned. The optical anisotropic layer may be formed by immobilizing the molecules by means of polymerization.

Regarding the film thickness of the optical anisotropic layer, the total film thickness of the optical anisotropic layer 1 and the optical anisotropic layer 2 may be 10 μm or smaller, smaller than 8 μm, 7 μm or smaller, 6 μm or smaller, 5 μm or smaller, 4 μm or smaller, 3 μm or smaller, 2 μm or smaller, 1.9 μm or smaller, 1.8 μm or smaller, 1.7 μm or smaller, 1.6 μm or smaller, 1.5 μm or smaller, 1.4 μm or smaller, 1.3 μm or smaller, 1.2 μm or smaller, 1.1 μm or smaller, or 1 μm or smaller and may be 0.2 μm or larger, 0.3 μm or larger, 0.4 μm or larger, 0.5 μm or larger, 0.6 μm or larger, 0.7 μm or larger, 0.8 μm or larger, or 0.9 μm or larger.

The optical anisotropic layer is also preferably transparent (for example, the light transmittance is 80% or higher).

[Optical Anisotropic Layer 1 and Optical Anisotropic Layer 2]

The transfer material used in the fabrication method of the present invention and a polarizing plate fabricated using the fabrication method of the present invention respectively include at least two optical anisotropic layers, and, in the present specification, the two optical anisotropic layers respectively included in the transfer material and the polarizing plate refer to the optical anisotropic layer 1 and the optical anisotropic layer 2. In the present specification, an optical anisotropic layer closer to the temporary support in the transfer material will be referred to as the optical anisotropic layer 1 and the other layer will be referred to as the optical anisotropic layer 2. Each of the transfer material and the polarizing plate may include optical anisotropic layers other than the optical anisotropic layer 1 and the optical anisotropic layer 2 or may include only the optical anisotropic layer 1 and the optical anisotropic layer 2 as the optical anisotropic layer.

The optical anisotropic layer 1 and the optical anisotropic layer 2 may be in contact with each other in a normal direction and may include other layers such as an alignment layer sandwiched therebetween. Polymerizable compositions forming the optical anisotropic layer 1 and the optical anisotropic layer 2 may be identical to each other or may be different from each other. For example, a combination of the two optical anisotropic layers may be a combination of layers formed of a composition including a rod-like liquid crystal compound or layers formed of a composition including a disc-like liquid crystal compound or a combination of a layer formed of a composition including a rod-like liquid crystal compound and a layer formed of a composition including a disc-like liquid crystal compound. The optical anisotropic layer 1 produced earlier may function as an alignment layer for the optical anisotropic layer 2 formed later. At this time, the surface of the optical anisotropic layer 1 may be rubbed.

The optical anisotropic layer 1 and the optical anisotropic layer 2 both have in-plane retardation, and the difference between the slow axis direction in the optical anisotropic layer 1 and the slow axis direction in the optical anisotropic layer 2 is in a range of 30 to 900. The present inventors found that, in the transfer material including the optical anisotropic layer 1 and the optical anisotropic layer 2, a problem of cracking is not easily caused even when the temporary support is peeled off. In a polarizing plate to be fabricated, a variety of optical compensations can be achieved by selecting the compositions of the optical anisotropic layer 1 and the optical anisotropic layer 2 or the alignment of the liquid crystal compound in various manners. The optical anisotropic layer 1 and the optical anisotropic layer 2 are still more preferably disposed so that the slow axis directions thereof form an angle of 50 or more with each other. The slow axis and the retardation can be measured using, for example, a polarization phase difference analyzer AxoScan manufactured by Axometrics, Inc.

At least two optical anisotropic layers in the polarizing plate, preferably, the optical anisotropic layer 1 and the optical anisotropic layer 2 preferably have a function of a λ/4 phase difference plate in association with each other. The λ/4 phase difference plate functions as a circular polarization plate in combination with a polarizer (linear polarizer).

The phase difference plate has an extremely large number of applications and has already been used in reflective-type LCDs, semi-transmissive-type LCDs, luminance-improving films, organic EL display devices, touch panels, and the like. For example, an organic electroluminescence (EL) element has a structure in which layers having different refractive indexes are laminated together or a structure in which a metal electrode is used, and thus external light is reflected at an interface between individual layers, and there are cases in which a problem of low contrast or image reflection is caused. Therefore, in order to suppress an adverse influence of external light reflection, a circular polarization plate constituted with a phase difference plate and a polarizing film has thus far been used in organic EL display devices, LCD display devices, and the like.

[Liquid Crystal Compound]

Examples of the liquid crystal compound include a rod-like liquid crystal compound and a disc-like liquid crystal compound.

As the rod-like liquid crystal compound, azomethine, azoxy, cyanobiphenyl, cyanophenyl ester, benzoic acid ester, cyclohexane phenyl carboxylate ester, cyanophenyl cyclohexane, cyano-substituted phenyl pyrimidine, alkoxy-substituted phenyl pyrimidine, phenyl dioxane, tolan, or alkenyl cyclohexyl benzonitrile is preferably used. Not only the above-described low-molecular-weight liquid crystalline molecule but also a high-molecular-weight liquid crystalline molecule can be used.

The alignment of the rod-like liquid crystal compound is preferably immobilized by means of polymerization, and as a polymerizable rod-like liquid crystal compound, it is possible to use the compounds described in Makromol. Chem., Vol. 190, p. 2255 (1989), Advanced materials Vol. 5, p. 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-10469A), JP1999-80081A (JP-H111-80081A), JP2001-328973A, JP2013-050583A, and the like. In addition, the polarizable rod-like liquid crystal compound is particularly preferably a polymerizable rod-like liquid crystal compound represented by General Formula (1) below.

Q¹-L¹-Cy¹-L²-(Cy²-L³)n-Cy³-L⁴-Q² General Formula (1)

(In General Formula (1), each of Q¹ and Q² independently represents a polymerizable group, each of L¹ and L⁴ independently represents a divalent linking group, each of L² and L³ independently represents a single bond or a divalent linking group, Cy¹, Cy², and Cy³ represent divalent cyclic groups, and n is 0, 1, 2, or 3.)

Hereinafter, the polymerizable rod-like liquid crystal compound represented by General Formula (1) will be described.

In General Formula (1), each of Q¹ and Q² independently represents a polymerizable group. The polymerization reaction of the polymerizable group is preferably addition polymerization (including ring-opening polymerization) or condensation polymerization. In other words, the polymerizable group is preferably a functional group capable of an addition polymerization reaction or a condensation polymerization reaction. Hereinafter, examples of the polymerizable group will be described.

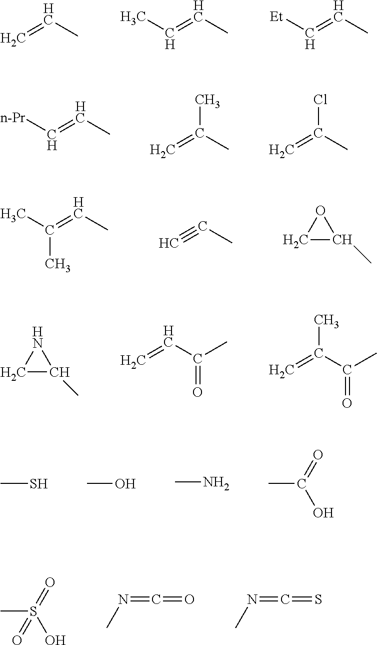

Among the above-illustrated polymerizable groups, an acryl group and a methacryl group are preferred. Particularly, in General Formula (1), both Q¹ and Q² are preferably acryl groups or methacryl groups.

In General Formula (1), each of L¹ and L⁴ independently represents a divalent linking group. Each of L¹ and L⁴ is, independently, preferably a divalent linking group selected from a group consisting of —O—, —S—, —CO—, —NR—, —C═N—, divalent chain-like groups, divalent cyclic groups, and combinations thereof. The R represents an alkyl group having 1 to 7 carbon atoms or a hydrogen atom. R is preferably an alkyl group having 1 to 4 carbon atoms or a hydrogen atom, more preferably a methyl group, an ethyl group, or a hydrogen atom, and still more preferably a hydrogen atom.

Examples of the divalent linking group formed of a combination thereof will be described below. Here, the left side is bonded to Q (Q¹ or Q²) and the right side is bonded to Cy (Cy¹ or Cy³).
L-1: —CO—O-divalent chain-like group-O—
L-2: —CO—O-divalent chain-like group-O—CO—
L-3: —CO—O-divalent chain-like group-O—CO—O—
L-4: —CO—O-divalent chain-like group-O-divalent cyclic group-
L-5: —CO—O-divalent chain-like group-O-divalent cyclic group-CO—O—
L-6: —CO—O-divalent chain-like group-O-divalent cyclic group-O—CO—
L-7: —CO—O-divalent chain-like group-O-divalent cyclic group-divalent chain-like group-
L-8: —CO—O-divalent chain-like group-O-divalent cyclic group-divalent chain-like group-CO—O—
L-9: —CO—O-divalent chain-like group-O-divalent cyclic group-divalent chain-like group-O—CO—
L-10: —CO—O-divalent chain-like group-O—CO-divalent cyclic group-
L-11: —CO—O-divalent chain-like group-O—CO-divalent cyclic group-CO—O—
L-12: —CO—O-divalent chain-like group-O—CO-divalent cyclic group-O—CO—
L-13: —CO—O-divalent chain-like group-O—CO-divalent cyclic group-divalent chain-like group-
L-14: —CO—O-divalent chain-like group-O—CO-divalent cyclic group-divalent chain-like group-CO—O—
L-15: —CO—O-divalent chain-like group-O—CO-divalent cyclic group-divalent chain-like group-O—CO—
L-16: —CO—O-divalent chain-like group-O—CO—O-divalent cyclic group-
L-17: —CO—O-divalent chain-like group-O—CO—O-divalent cyclic group-CO—O—
L-18: —CO—O-divalent chain-like group-O—CO—O-divalent cyclic group-O—CO—
L-19: —CO—O-divalent chain-like group-O—CO—O-divalent cyclic group-divalent chain-like group-
L-20: —CO—O-divalent chain-like group-O—CO—O-divalent cyclic group-divalent chain-like group-CO—O—
L-21: —CO—O-divalent chain-like group-O—CO—O-divalent cyclic group-divalent chain-like group-O—CO—

The divalent chain-like group refers to an alkylene group, a substituted alkylene group, an alkenylene group, a substituted alkenylene group, an alkynylene group, and a substituted alkynylene group. An alkylene group, a substituted alkylene group, an alkenylene group, and a substituted alkenylene group are preferred, and an alkylene group and an alkenylene group are more preferred.

The alkylene group may have a branch. The number of carbon atoms in the alkylene group is preferably in a range of 1 to 12, more preferably in a range of 2 to 10, and still more preferably in a range of 2 to 8.

An alkylene part in the substituted alkylene group is identical to the alkylene group. Examples of a substituent include halogen atoms.

The alkenylene group may have a branch. The number of carbon atoms in the alkenylene group is preferably in a range of 2 to 12, more preferably in a range of 2 to 10, and still more preferably in a range of 2 to 8.

An alkenylene part in the substituted alkenylene group is identical to the alkenylene group. Examples of a substituent include halogen atoms.

The alkynylene group may have a branch. The number of carbon atoms in the alkynylene group is preferably in a range of 2 to 12, more preferably in a range of 2 to 10, and still more preferably in a range of 2 to 8.

An alkynylene part in the substituted alkynylene group is identical to the alkynylene group. Examples of a substituent include halogen atoms.

Specific examples of the divalent chain-like group include ethylene, trimethylene, propylene, tetramethylene, 2-methyl-tetramethylene, pentamethylene, hexamethylene, octamethylene, 2-butenylene, and 2-butynylene.

The definition and examples of the divalent cyclic group are identical to the definition and examples of Cy¹, Cy², and Cy³ described below.

In General Formula (1), each of L² and L³ independently represents a single bond or a divalent linking group. Each of L² and L³ is, independently, preferably a divalent linking group selected from a group consisting of —O—, —S—, —CO—, —NR—, —C═N—, divalent chain-like groups, divalent cyclic groups, and combinations thereof. The R represents an alkyl group having 1 to 7 carbon atoms or a hydrogen atom, preferably an alkyl group having 1 to 4 carbon atoms or a hydrogen atom, more preferably a methyl group, an ethyl group, or a hydrogen atom, and still more preferably a hydrogen atom. The definitions of the divalent chain-like group and the divalent cyclic group are identical to the definitions of L¹ and L⁴.

Preferred examples of the divalent linking group that is L² or L³ include —COO—, —OCO—, —OCOO—, —OCONR—, —COS—, —SCO—, —CONR—, —NRCO—, —CH₂CH₂—, —C═C—COO—, —C═N—, and —C═N—N═C—.

In General Formula (1), n is 0, 1, 2, or 3. In a case in which n is 2 or 3, two L³'s may be identical to each other or different from each other, and two Cy²'s may be identical to each other or different from each other. n is preferably 1 or 2 and more preferably 1.

In General Formula (1), each of Cy¹, Cy², and Cy³ independently represents a divalent cyclic group.

A ring in the cyclic group is preferably a five-membered ring, a six-membered ring, or a seven-membered ring, more preferably a five-membered ring or a six-membered ring, and most preferably a six-membered ring.

A ring in the cyclic group may be a fused ring. However, a single ring is more preferred than a fused ring.

A ring in the cyclic group may be any one of an aromatic ring, an aliphatic ring, and a heterocyclic ring. Examples of the aromatic ring include a benzene ring and a naphthalene ring. Examples of the aliphatic ring include a cyclohexane ring. Examples of the heterocyclic ring include a pyridine ring and a pyrimidine ring.

The cyclic group including a benzene ring is preferably 1,4-phenylene. The cyclic group including a naphthalene ring is preferably naphthalene-1,5-diyl or naphthalene-2,6-diyl. The cyclic group including a cyclohexane ring is preferably 1,4-cyclohexylene. The cyclic ring including a pyridine ring is preferably pyridine-2,5-diyl. The cyclic group including a pyrimidine ring is preferably pyrimidine-2,5-diyl.

The cyclic group may have a substituent. Examples of the substituent include halogen atoms, a cyano group, a nitro group, alkyl groups having 1 to 5 carbon atoms, halogen-substituted alkyl groups having 1 to 5 carbon atoms, alkoxy groups having 1 to 5 carbon atoms, alkylthio groups having 1 to 5 carbon atoms, acyloxy groups having 2 to 6 carbon atoms, alkoxycarbonyl groups having 2 to 6 carbon atoms, a carbamoyl group, alkyl-substituted carbamoyl groups having 2 to 6 carbon atoms, and acylamino groups having 2 to 6 carbon atoms.

Hereinafter, examples of the polymerizable rod-like liquid crystal compound represented by General Formula (1) will be described, but examples of the polymerizable rod-like liquid crystal compound are not limited thereto.

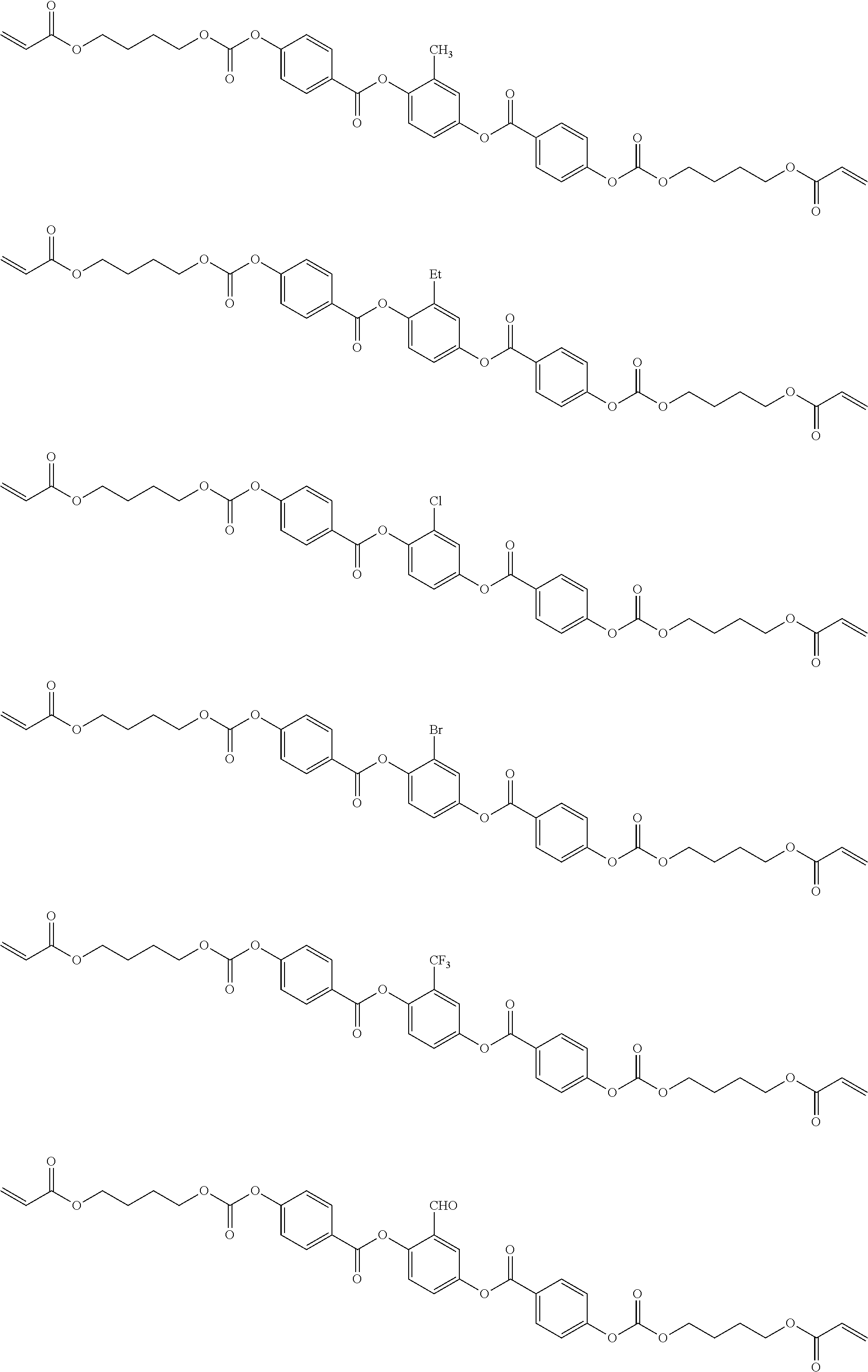

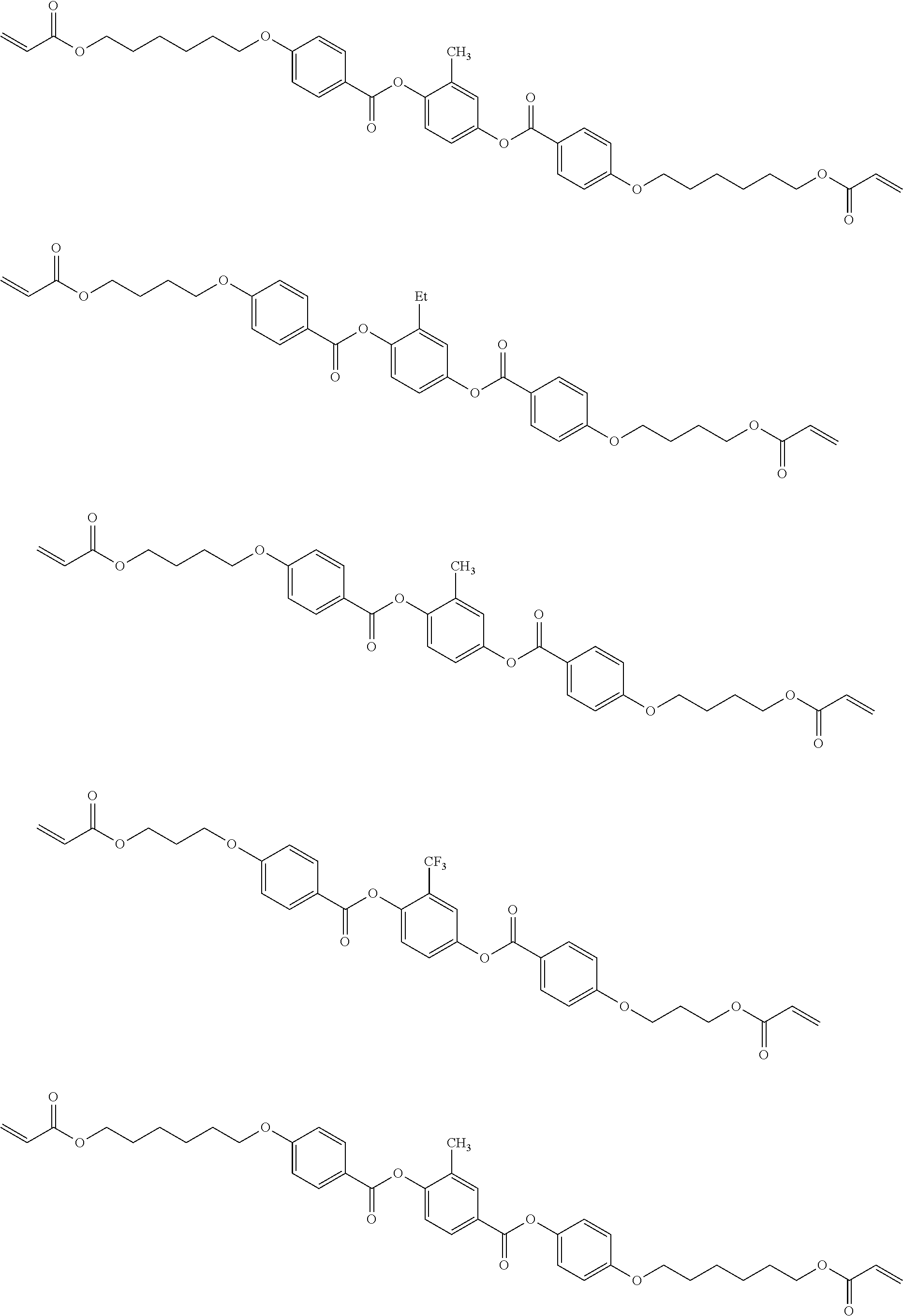

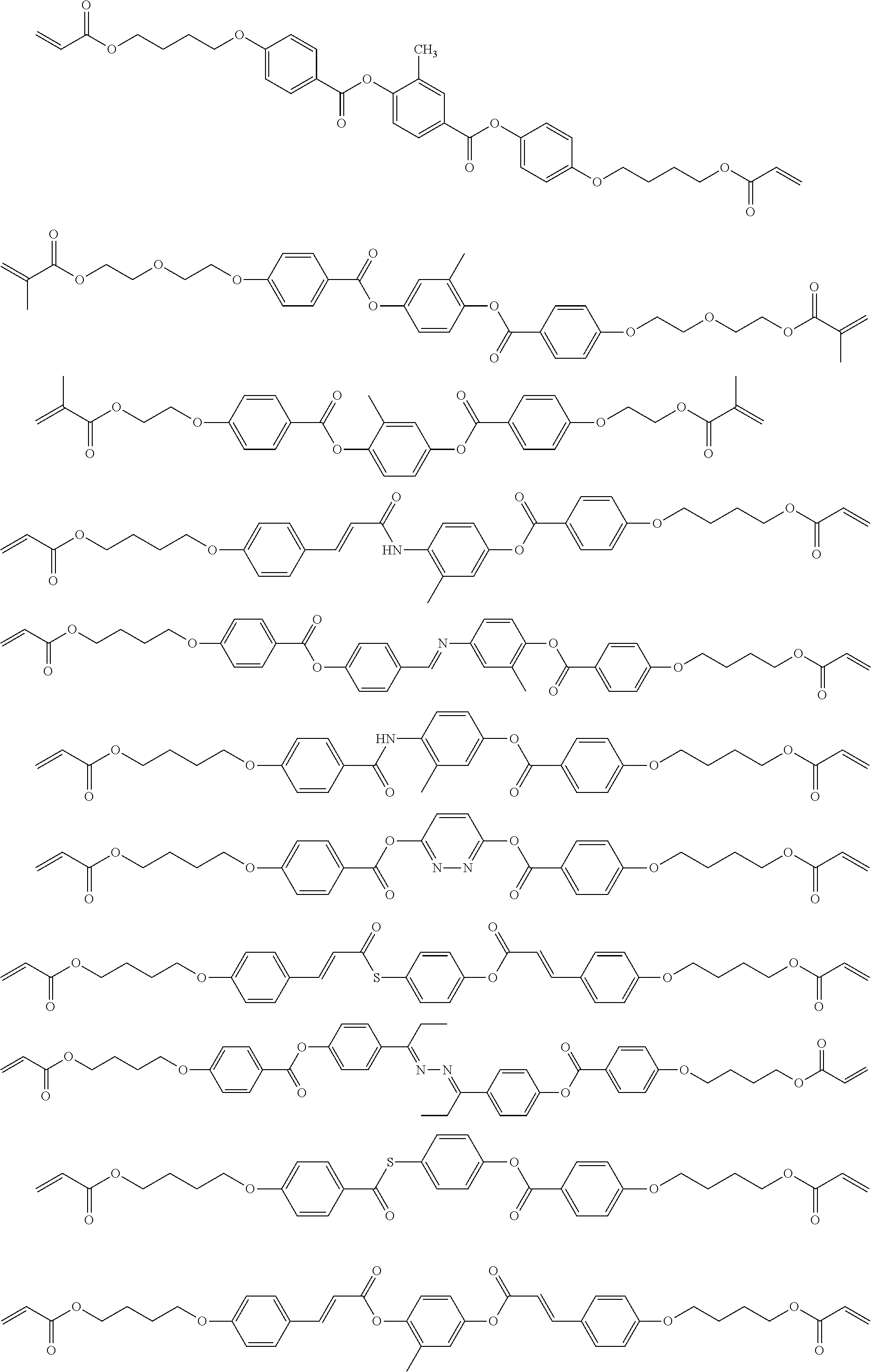

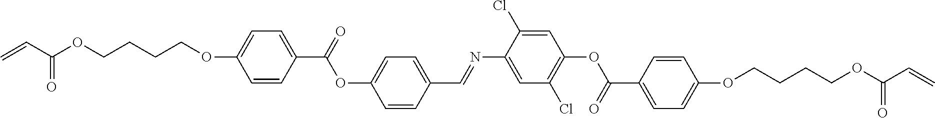

In addition, as the rod-like liquid crystal compound, it is preferable to jointly use at least one of the compounds represented by General Formula (2) below together with the polymerizable rod-like liquid crystal compound represented by General Formula (1).

M¹-(L¹)p-Cy¹-L²(Cy²-L³)n-Cy³-(L⁴)q-M² General Formula (2)

(In General Formula (2), each of M¹ and M² independently represents a hydrogen atom, a substituted or unsubstituted alkyl group, a substituted or unsubstituted aryl group, a heterocyclic group, a cyano group, a halogen, —SCN, —CF₃, a nitro group, or Q¹, but at least one of M¹ and M² represents a group other than Q¹.

Here, Q¹, L¹, L², L³, L⁴, Cy¹, Cy², Cy³, and n are identical to the groups represented by General Formula (1). In addition, p and q are 0 or 1.

In a case in which M¹ and M² do not represent Q¹, M¹ and M² are preferably hydrogen atoms, substituted or unsubstituted alkyl groups, substituted or unsubstituted aryl groups, and cyano groups and more preferably alkyl groups having 1 to 4 carbon atoms or phenyl groups, and p and q are preferably 0.

In addition, a preferred mixing percentage (mass ratio) of the compound represented by General Formula (2) in a mixture of the polymerizable liquid crystal compound represented by General Formula (1) and the compound represented by General Formula (2) is in a range of 0.1% to 40%, more preferably in a range of 1% to 30%, and still more preferably in a range of 5% to 20%.

Hereinafter, preferred examples of the compound represented by General Formula (2) will be described, but the present invention is not limited thereto.

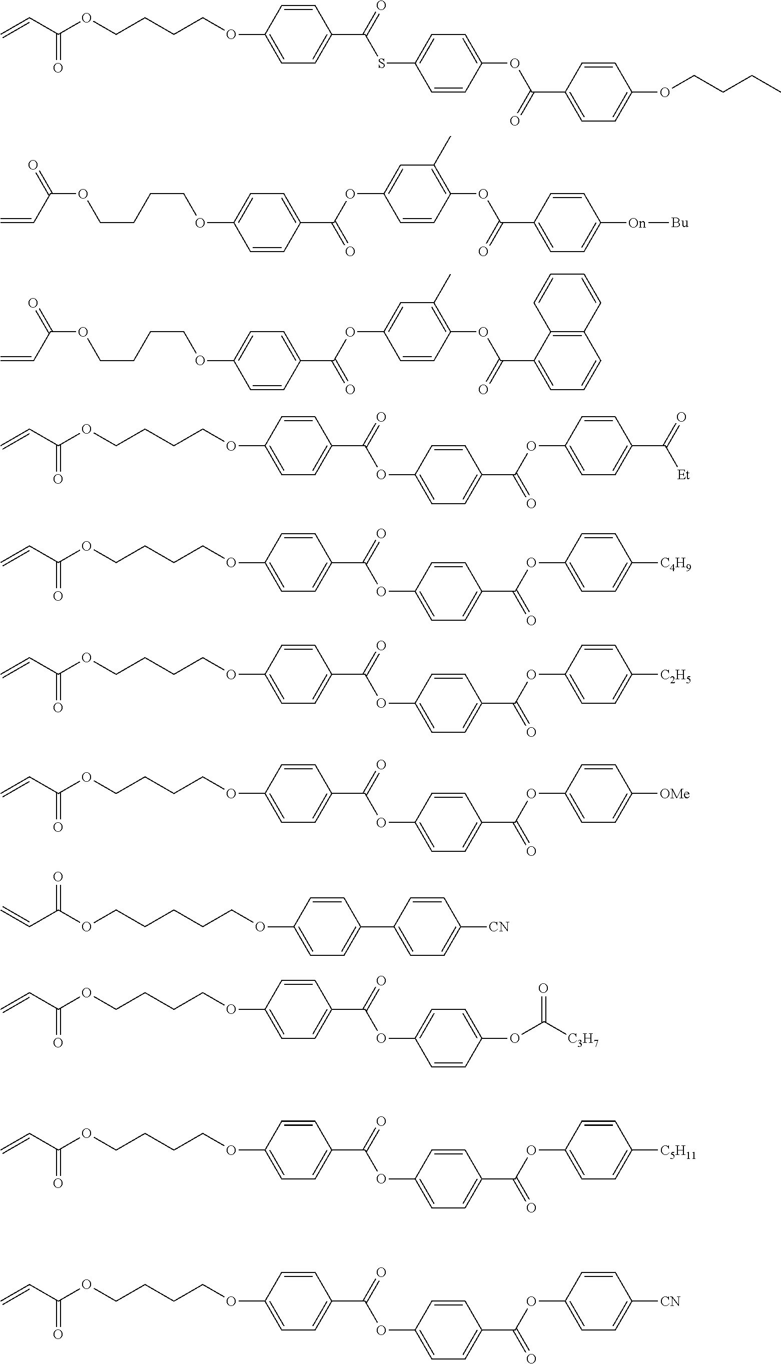

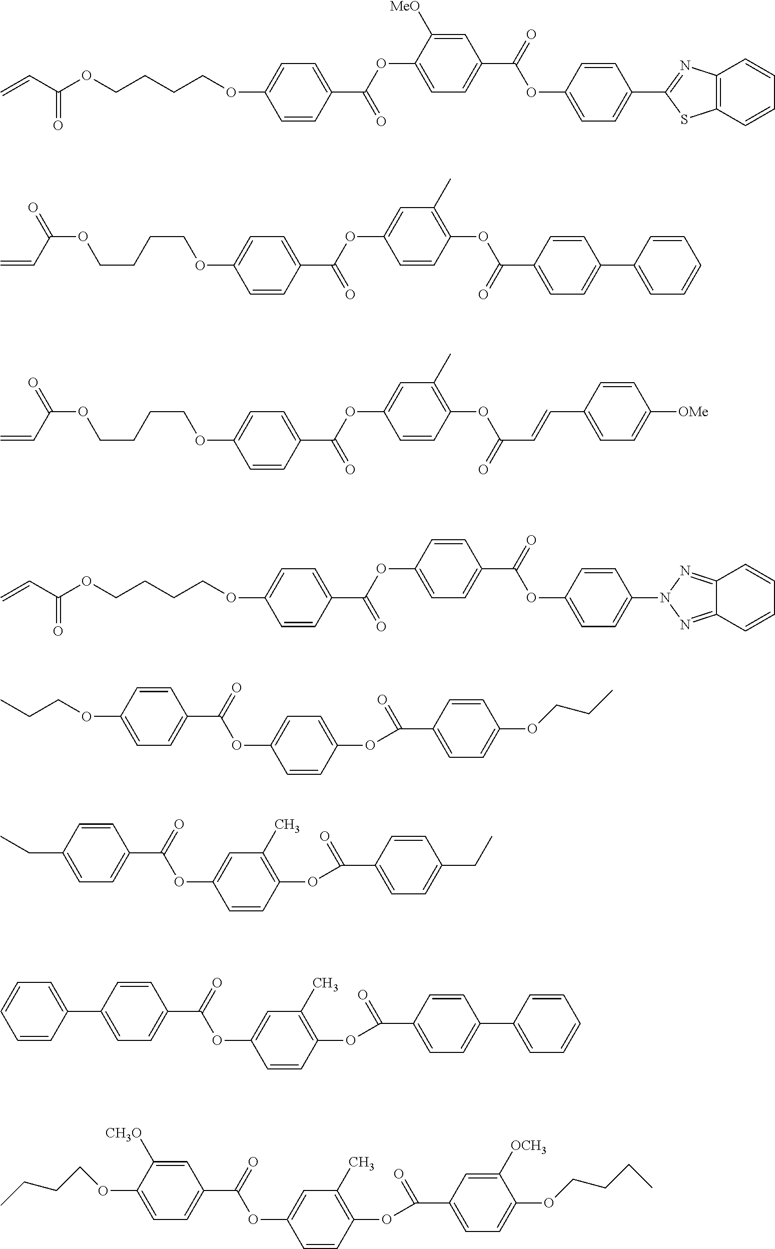

The disc-like liquid crystal compound is described in a variety of publications (C. Destrade et al., Mol. Cryst. Liq. Cryst., vol. 71, page 111 (1981); The Chemical Society of Japan, Kikan Kagaku Sosetsu, No. 22, Chemistry of liquid crystals, Chapter 5, Section 2 of Chapter 10 (1994); B. Kohne et al., Angew. Chem. Soc. Chem. Comm., page 1794 (1985); J. Zhang et al., J. Am. Chem. Soc., vol. 116, page 2655 (1994)). Polymerization of the disc-like liquid crystal compound is described in JP1996-27284A (JP-H08-27284A). In order to immobilize the disc-like alignment layer liquid crystal compound by means of polymerization, it is necessary to bond a polymerizable group as a substituent to a disc-like core of the disc-like liquid crystal compound. However, when the polymerizable group is directly bonded to the disc-like core, it becomes difficult to maintain the alignment state during the polymerization reaction. Therefore, a linking group is introduced between the disc-like core and the polymerizable group. That is, the photocurable disc-like liquid crystal compound is preferably a compound represented by General Formula (3).

D(-L-P)n General Formula (3)

(In the general formula, D represents the disc-like core, L represents a divalent linking group, P represents a polymerizable group, and n represents an integer from 4 to 12.) Preferred specific examples of the disc-like core (D), the divalent linking group (L), and the polymerizable group (P) in General Formula (3) are respectively (D1) to (D15), (L1) to (L25), and (P1) to (P18) described in JP2001-4837A, and the contents of the same publication can be preferably used.

In addition, as the disc-like liquid crystal compound, it is preferable to use the compound represented by General Formula (DI) described in JP2007-2220A.

The content of the liquid crystal compound may be 80% by mass or more, 90% by mass or more, or 95% by mass or more and may be 99.99% by mass or less, 99.98% by mass or less, or 99.97% by mass or less of the solid content mass (the mass of the composition excluding the solvent) of the polymerizable composition. Particularly, the content of a compound including an acrylic group or a methacrylic group is preferably 70% by mass or more, 80% by mass or more, 90% by mass or more, or 95% by mass or more and is preferably 99.99% by mass or less, 99.98% by mass or less, or 99.97% by mass or less.

The liquid crystal compound may be immobilized in any alignment state of horizontal alignment, vertical alignment, tilt alignment, and twisted alignment. Meanwhile, in the present specification, “horizontal alignment” means that, in the case of rod-like liquid crystals, the molecular long axis and the horizontal surface of a transparent support are parallel to each other and, in the case of disc-like liquid crystals, the disc surface of the core of the disc-like liquid crystal compound and the horizontal surface of a transparent support are parallel to each other. However, the molecular long axis or the disc surface of the core and the horizontal surface of a transparent support are not necessarily accurately parallel to each other, and, in the present specification, the inclination angle therebetween needs to be less than 10 degrees. As the optical anisotropic layer used in the present invention, an optical anisotropic layer in which the rod-like liquid crystal compound is immobilized in a horizontal alignment state is preferably included.

[Solvent]

As a solvent used for the preparation of a coating liquid in a case in which the composition including the liquid crystal compound is prepared as the coating liquid, an organic solvent, water, or a solvent mixture thereof is preferably used. Examples of the organic solvent include amides (for example, N,N-dimethylformamide), sulfoxides (for example, dimethylsulfoxide), heterocyclic compounds (for example, pyridine), hydrocarbons (for example, benzene and hexane), alkyl halides (for example, chloroform and dichloromethane), esters (for example, methyl acetate and butyl acetate), ketones (for example, acetone, methyl ethyl ketone, methyl isobutyl ketone, and cyclohexanone), ethers (for example, tetrahydrofuran and 1,2-dimethoxyethane), and alkyl alcohols (for example, methanol, ethanol, and propanol). In addition, a mixture of two or more solvents may be used. Among these, alkyl halides, esters, ketones, and solvent mixtures thereof are preferred.

[Alignment Immobilization]

The alignment of the liquid crystal compound is preferably immobilized using a crosslinking reaction of the polymerizable group introduced into the liquid crystal compound and more preferably immobilized using a polymerization reaction of the polymerizable group. Examples of the polymerization reaction include a thermopolymerization reaction for which a thermopolymerization initiator is used and a photopolymerization reaction for which a photopolymerization initiator is used. The polymerization reaction may be any one of radical polymerization and cation polymerization and is preferably radical polymerization. Examples of the radical photopolymerization initiator include α-carbonyl compounds (described in the respective specifications of U.S. Pat. No. 2,367,661A and U.S. Pat. No. 2,367,670A), acyloin ethers (described in the specification of U.S. Pat. No. 2,448,828A), α-hydrocarbon-substituted aromatic acyloin compounds (described in the specification of U.S. Pat. No. 2,722,512A), polynuclear quinone compounds (described in the respective specifications of U.S. Pat. No. 3,046,127A and U.S. Pat. No. 2,951,758A), combinations of triarylimidazole dimer and p-aminophenyl ketone (described in the specification of U.S. Pat. No. 3,549,367A), acridine and phenazine compounds (JP1985-105667A (JP-S60-105667A) and the specification of U.S. Pat. No. 4,239,850A), and oxadiazole compounds (described in the specification of U.S. Pat. No. 4,212,970A). Examples of the cation photopolymerization initiator include organic sulfonium salt-based photocurable initiators, iodonium-based photopolymerization initiators, phosphonium salt-based photocurable initiators, and the like, and organic sulfonium salt-based photocurable initiators are preferred, and triphenyl sulfonium salt is particularly preferred. As a counter ion of the above-described compound, hexafluoroantimonate, hexafluorophosphate, and the like are preferably used.

The radical thermopolymerization initiator is a compound that generates a radical when heated to the decomposition temperature or higher. Examples of the radical thermopolymerization initiator include diacyl peroxides (acetyl peroxide, benzoyl peroxide, and the like), ketone peroxides (methyl ethyl ketone peroxide, cyclohexanone peroxide, and the like), hydroperoxides (hydrogen peroxide, tert-butyl hydroperoxide, cumene hydroperoxide, and the like), dialkyl peroxides (di-tert-butyl peroxide, dicumyl peroxide, dilauroyl peroxide, and the like), peroxide esters (tert-butyl peroxyacetate, tert-butyl peroxypivalate, and the like), azo-based compounds (azobis isobutyronitrile, azobis isovaleronitrile, and the like), and pulsulfates (ammonium persulfate, sodium persulfate, potassium persulfate, and the like).

The amount of the polymerization initiator used is preferably in a range of 0.01% by mass to 20% by mass and more preferably in a range of 0.5% by mass to 5% by mass of the solid content of the coating liquid. In optical irradiation for the photopolymerization of the liquid crystal compound, ultraviolet rays are preferably used. The irradiation energy is preferably in a range of 10 mJ/cm² to 10 J/cm² and more preferably in a range of 25 mJ/cm² to 1000 J/cm². The illuminance is preferably in a range of 10 mW/cm² to 2000 mW/cm², more preferably in a range of 20 mW/cm² to 1500 mW/cm², and still more preferably in a range of 40 mW/cm² to 1000 mW/cm². The irradiation wavelength preferably has a peak in a range of 250 nm to 450 nm, and still more preferably has a peak in a range of 300 nm to 410 nm. The optical irradiation may be carried out in an inert gas atmosphere such as nitrogen or under heating conditions in order to accelerate the photopolymerization reaction.

Heating for the thermopolymerization of the liquid crystal compound is preferably carried out in a temperature range of 50° C. to 200° C. for 10 minutes to 30 hours.

[Horizontal Alignment Agent]

When the polymerizable composition including the liquid crystal compound includes at least one of fluorine-containing homopolymers or copolymers for which the compounds represented by General Formulae (1) to (3) and a monomer of General Formula (4), which are described in Paragraphs “0098” to “0105” of JP2009-69793A, are used, it is possible to horizontally align the molecules of the liquid crystal compound. In a case in which the liquid crystal compound is horizontally aligned, the inclination angle is preferably in a range of 0 degrees to 5 degrees, more preferably in a range of 0 degrees to 3 degrees, still more preferably in a range of 0 degrees to 2 degrees., and most preferably in a range of 0 degrees to 1 degree.

The amount of the horizontal alignment agent added is preferably in a range of 0.01% by mass to 20% by mass, more preferably in a range of 0.01% by mass to 10% by mass, and particularly preferably in a range of 0.02% by mass to 1% by mass of the mass of the liquid crystal compound. Meanwhile, the compounds represented by General Formulae (1) to (4) described in Paragraphs “0098” to “0105” of JP2009-69793A may be singly used or two or more compounds may be jointly used.

[Other Additives]

The polymerizable composition including the liquid crystal compound may also include the niobium salt described in Paragraphs “0121” to “0148” of JP2013-050583A and particularly the pyridinium compound represented by Formula (I) described in JP2006-113500A. The niobium salt is capable of functioning as an alignment layer interface-side vertical alignment agent, and, for example, capable of vertically aligning the molecules of a discotic liquid crystal compound in the vicinity of the alignment layer. In addition, the polymerizable composition including the liquid crystal compound may also include the boronic acid compound represented by General Formula (I) described in JP2013-054201A.

The polymerizable composition including the liquid crystal compound may also include other necessary additives, but preferably does not include a so-called chiral agent.

[Coating Method]

During the formation of the optical anisotropic layer, the composition can be applied using a dip coating method, an air knife coating method, a spin coating method, a slit coating method, a curtain coating method, a roller coating method, a wire bar coating method, a gravure coating method, or an extrusion coating method (the specification of U.S. Pat. No. 2,681,294A). Two or more layers may be coated at the same time. A method for simultaneous coating is described in the respective specifications of U.S. Pat. No. 2,761,791A, U.S. Pat. No. 2,941,898A, U.S. Pat. No. 3,508,947A, and U.S. Pat. No. 3,526,528A and Yuji Harazaki, Coating Engineering, page 253, Asakura Publishing Co., Ltd. (1973).

[Temporary Support]

The temporary support is not particularly limited, and a stiff support or a flexible support may be used, but a flexible support is preferred in terms of easy handling. The stiff support is not particularly limited, and examples thereof include well-known glass plates such as a soda glass plate including a silicon oxide film on the surface, low-expansion glass plate, non-alkali glass plate, and a silica glass plate, metal plates such as an aluminum plate, a steel plate, and an SUS plate, resin plates, ceramic plates, and stone plates. The flexible support is not particularly limited, and examples thereof include plastic films such as cellulose esters (for example, cellulose acetate, cellulose propionate, and cellulose butyrate), polyolefin (for example, norbornene-based polymers), poly(meth)acrylic acid esters (for example, polymethyl methacrylate), polycarbonate, polyesters (for example, polyethylene terephthalate and polyethylene naphthalate), polysulfone, and cycloolefin polymers (for example, norbornene-based resins (ZEONEX and ZEONOA manufactured by ZEON Corporation and ARTON manufactured by JSR Corporation)), paper, aluminum foil, and fabric. Among these, polyethylene terephthalate (PET) is more preferred. In terms of easy handling, the film thickness of the stiff support is preferably in a range of 100 μm to 3000 μm and more preferably in a range of 300 μm to 1500 μm. The film thickness of the flexible support may be in a range of approximately 5 μm to 1000 μm and is preferably in a range of 10 μm to 250 μm and more preferably in a range of 15 μm to 90 μm.

[Alignment Layer]

For the formation of the optical anisotropic layer, an alignment layer may be used. The alignment layer may be provided on the temporary support, on an undercoat layer provided on the temporary support by means of coating, or on the surface of the optical anisotropic layer 1. The alignment layer functions so as to regulate the alignment of the liquid crystal compound in the polymerizable composition provided on the alignment layer. As the alignment layer, any layer may be used as long as the layer is capable of imparting alignment properties to the optical anisotropic layer. It is also possible to select not only a well-known material of a vertical alignment film but also a well-known material for a horizontal alignment film. Examples of the alignment layer include a layer made of an organic compound (preferably a polymer), a light alignment layer which is represented by an azobenzene polymer or a polyvinyl cinnamate and in which the alignment properties of liquid crystals are developed by means of optical irradiation, an oblique deposition layer of an inorganic compound, a layer having a microgroove, furthermore, a built-up film formed by means of a Langmuir-Blodgett method (LB film) of ω-tricosanoic acid, dioctanedecylmethylammonium chloride, and methyl stearate, and layers obtained by aligning a dielectric body by means of application of an electric field or a magnetic field. The alignment layer is preferably a polymer layer and particularly preferably a polymer layer including modified or unmodified polyvinyl alcohol. The modified or unmodified polyvinyl alcohol is also used as a horizontal alignment film; however, when an onium compound is added to a composition for forming an optical anisotropic layer, it is possible to align liquid crystal molecules in a tilt alignment state with a high average tilt angle or a vertical alignment state due to an action between the onium compound and the alignment film and an action between the onium compound and the liquid crystal compound. The modified polyvinyl alcohol refers to polyvinyl alcohol in which at least one hydroxyl group in the polyvinyl alcohol is modified by a functional group, and examples thereof include polyvinyl alcohols which are modified with an acetoacetyl group, a sulfonic acid group, a carboxyl group, an oxyalkylene group, or the like. As the alignment film, an alignment film including the modified polyvinyl alcohol including a unit having a polymerizable group is preferably used. This is because adhesiveness to the optical anisotropic layer can be further improved. Furthermore, polyvinyl alcohol in which at least one hydroxyl group is substituted with a group having a vinyl portion, an oxiranyl portion, or an aziridinyl portion is preferred, and, for example, the modified polyvinyl alcohol described in Paragraphs “0071” to “0095” of JP3907735B is preferred.

The thickness of the alignment layer is preferably in a range of 0.01 μm to 5 μm and more preferably in a range of 0.05 μm to 2 μm.

(Rubbing Treatment)

The surface of the alignment layer, the temporary support, or the optical anisotropic layer 1 to which the polymerizable composition is applied is preferably subjected to a rubbing treatment. The rubbing treatment carried out on the alignment layer can be carried out by, generally, rubbing the surface of a film including a polymer as a main component with paper or fabric in a constant direction. An ordinary method of the rubbing treatment is described in, for example, “Handbook of Liquid Crystals” (published by Maruzen Co., Ltd., Oct. 30, 2000).

As a method for changing the rubbing density, it is possible to use the method described in “Handbook of Liquid Crystals” (published by Maruzen Co., Ltd.). The rubbing density (L) is quantified by Equation (A) below.

L=NI(1+2πrn/60v) Equation (A)

In Equation (A), N represents the number of times of rubbing, I represents the contact length of a rubbing roller, r represents the radius of the roller, n represents the rotation speed of the roller (rpm), and v represents the stage migration speed (per second).

In order to increase the rubbing density, it is necessary to increase the number of times of rubbing, increase the contact length of the rubbing roller, increase the radius of the roller, increase the rotation speed of the roller, and decrease the stage migration speed. On the other hand, in order to decrease the rubbing density, it is necessary to adjust the above-described factors inversely.

In addition, regarding the conditions of the rubbing treatment, the description of JP4052558B can be referred to.

[Other Functional Layers]

The transfer material or the polarizing plate may include, in addition to the above-described layers, other functional layers such as a layer of low moisture permeability, a protective layer, an antistatic layer, a hard coat layer, an adhesive layer, a mold release layer, and a release layer.

The transfer material may include other functional layers; however, in the fabrication method of the present invention, even when the transfer material does not include any protective films or the like on the surface of the optical anisotropic layer or a layer formed of the polymerizable composition including the liquid crystal compound, it is possible to transfer (bring the transfer body into contact with the film including the polarizer) the optical anisotropic layer to the polarizer.

Mold Release Layer

The mold release layer refers to a layer which is provided between the temporary support and the transfer body and, in the fabrication method of the present invention, is peeled off from the temporary support together with the transfer material. The use of the mold release layer stabilizes the peeling of the transfer body from the temporary support and enables to improve transfer properties during transfer.

As the mold release layer, it is possible to apply a mold-releasing resin, a resin including a mold release agent, a curable resin that is crosslinked by means of optical irradiation, or the like. Examples of the mold-releasing resin include fluorine-based resins, silicone, melamine-based resins, an epoxy resin, a polyester resin, an acrylic resin, and cellulose-based resins, and melamine-based resins are preferred. Examples of the resin including a mold release agent include fluorine-based resins, silicone, acrylic resins obtained by adding or copolymerizing a mold release agent such as a variety of waxes to or with the resin, vinyl-based resins, polyester resins, and cellulose-based resins.

The mold release layer may be formed by dispersing or dissolving the resin in a solvent, applying the solution using a well-known coating method such as roll coating or gravure coating, and drying the solution. In addition, if necessary, the solution may be dried by being heated at a temperature in a range of 30° C. to 120° C., be aged, or be crosslinked by being irradiated with ionizing radiation. The thickness of the mold release layer is generally in a range of approximately 0.01 μm to 5.0 μm and preferably in a range of approximately 0.5 μm to 3.0 μm.

Release Layer

The release layer refers to a layer which is provided between the temporary support and the transfer body and serves as an outermost surface of the transfer body obtained by peeling the temporary support from the transfer material. The use of the release layer stabilizes the peeling of the temporary support from the transfer material. Since the release layer serves as the outermost surface of the transfer body, the release layer preferably has surface-protecting properties.

A material for the release layer is not particularly limited as long as the release layer can be peeled off from the temporary support and can be closely adhered to an adjacent layer (the alignment layer, the patterned optical anisotropic layer, or the like) formed on a side of the release layer opposite to the temporary support, and, for example, it is possible to use an acrylic resin, a vinyl chloride-vinyl acetate copolymer resin, a polyester resin, a polymethacrylate ester resin, a polyvinyl chloride resin, a cellulose resin, a silicone resin, chloride rubber, casein, a metal oxide, or the like. It is also possible to use two or more materials in a mixed form. In addition, a fluorine-based resin, silicone, a mold release agent such as a variety of waxes, a variety of surfactants, and the like may be added to or copolymerized with the material.

In the transfer material, it is also preferable that the optical anisotropic layer 1 or the alignment layer serves as the release layer.

[Polarizer]

Examples of the polarizer include iodine-based polarizers, dye-based polarizers for which a dichromatic dye is used, and polyene-based polarizers. The iodine-based polarizers and the dye-based polarizers are generally fabricated using a polyvinyl alcohol-based film. In the fabrication method of the present invention, any polarizer may be used. For example, the polarizer is preferably constituted with modified or unmodified polyvinyl alcohol and dichromatic molecules. Regarding the polarizer constituted with modified or unmodified polyvinyl alcohol and dichromatic molecules, for example, the description of JP2009-237376A can be referred to. The film thickness of the polarizer needs to be 50 μm or smaller and is preferably 30 μm or smaller and more preferably 20 μm or smaller. In addition, the film thickness of the polarizer, generally, needs to be 1 μm or larger, 5 μm or larger, or 10 μm or larger.

[Polarizing Plate Production Method]

The fabrication method of the present invention includes (2) peeling the temporary support in the transfer material and separating the temporary support and the transfer body and (3) adhering the transfer body to the film including the polarizer. The order may be (2) and (3) or (3) and (2). The surface of the transfer body which is adhered to the film including the polarizer may be a surface obtained due to the peeling of the temporary support or a surface opposite thereto; however, in a case in which the transfer body is transferred to the film in the order of (3) and (2), the surface of the transfer body opposite to the temporary support side when seen from the optical anisotropic layer 1 is adhered to the film including the polarizer. The surface of the transfer body which is adhered to the film including the polarizer may be a surface of any one of the optical anisotropic layer 1, the optical anisotropic layer 2, the alignment layer, and the release layer.

A method for peeling the temporary support is not particularly limited. The temporary support is preferably peeled at a speed at which the transfer body does not break.

In a case in which the transfer material to be prepared is larger than the polarizing plate to be produced, the transfer material may be cut before the peeling of the temporary support. For example, the transfer material cut into a roll shape having a width of 1.5 m or larger may be cut into an arbitrary shape such as a square shape or a rectangular shape having a size of, for example, approximately 0.1 m² or lower, 0.05 m² or lower, 0.03 m² or lower, 0.025 m² or lower, 0.02 m² or lower, 0.01 m² or lower, 0.005 m² or lower, or 0.003 m² or lower. The lower limit of the above-described shape is not particularly limited, and the shape may have a size large enough to be handled according to the purpose, and the size may be generally approximately 0.0001 m² (1 cm²) or larger.

The outermost surface of the transfer body may be adhered to the polarizer in the film including the polarizer or to a layer other than the polarizer, but is preferably adhered to the polarizer. The outermost surface of the transfer body may be the alignment layer, and the alignment layer may be directly adhered to the polarizer. At this time, in a case in which the alignment layer is a layer including polyvinyl alcohol, and the polarizer includes polyvinyl alcohol, particularly adhesiveness is favorable.

In the present specification, adhering means either adhering or gluing. The surface may be adhered to the film through an adhesive layer. Any layers may be used as the adhesive layer as long as the layers include an adhesive or a gluing agent. That is, the transfer body and the film including the polarizer may be adhered or glued together using an adhesive or a gluing agent.

The adhesive is not particularly limited, and examples thereof include polyvinyl alcohol-based adhesives, aqueous solutions of a boron compound, curable adhesives of an epoxy compound not including an aromatic ring in the molecule as described in JP2004-245925A, active energy ray-curable adhesives including as essential components a photopolymerization initiator having a molar light absorption coefficient of 400 or higher at a wavelength in a range of 360 nm to 450 nm and an ultraviolet-curable compound described in JP2008-174667A, and active energy ray-curable adhesives including (a) a (meth)acrylic compound having 2 or more (meth)acryloyl groups in the molecule, (b) a (meth)acrylic compound having a, hydroxyl group in the molecule and having only one polymerizable double bond, and (c) phenol-ethylene oxide-modified acrylate or nonylphenol ethylene oxide-modified acrylate in a total amount of 100 parts by mass of a (meth)acrylic compound.

Among these, particularly, polyvinyl alcohol-based adhesives are preferred. Meanwhile, the polyvinyl alcohol-based adhesive is an adhesive including modified or unmodified polyvinyl alcohol. The polyvinyl alcohol-based adhesive may include, in addition to modified or unmodified polyvinyl alcohol, a crosslinking agent. Specific examples of the adhesive include aqueous solutions of polyvinyl alcohol or polyvinyl acetal (for example, polyvinyl butyral) and latex of a vinyl-based polymer (for example, polyvinyl chloride, polyvinyl acetate, and polybutyl acrylate). A particularly preferred adhesive is an aqueous solution of polyvinyl alcohol. At this time, fully-saponified polyvinyl alcohol is preferred.

The thickness of the adhesive layer is preferably in a range of 0.01 μm to 10 μm and particularly preferably in a range of 0.05 μm to 5 μm in terms of the dried film thickness.

[Film Including Polarizer]

The film including the polarizer to which the transfer body is adhered may be made of only the polarizer or may include the polarizer and other layers such as a protective film.

(Protective Film (Protective Layer))

The polarizing plate preferably includes a protective film. For example, the film including the polarizer may be produced by providing protective films on either or both surfaces of the polarizer. In addition, in the transfer material, a protective film may be provided on a side of the polarizer opposite to the temporary support, preferably, on the outermost surface, when seen from the optical anisotropic layer 1. Alternatively, after the transfer body and the film including the polarizer are adhered together, protective films may be provided on any one or both surfaces.

The protective film may be provided so as to come into direct contact with other layers using a method in which, for example, a composition for forming the protective film is directly applied and dried on a surface on which the protective film is provided; however, generally, the protective film may be adhered to the surface using an adhesive or a gluing agent. Examples of the adhesive or the gluing agent include the same adhesive or gluing agent as those used for adhering the transfer body and the film including the polarizer.

As the protective film, it is possible to use a cellulose acylate-based polymer film, an acrylic polymer film, or a cycloolefin-based polymer film. Regarding the cellulose acylate-based polymer, the description regarding the cellulose acylate-based resin of JP2011-237474A can be referred to. Regarding the cycloolefin-based polymer film, the description of JP2009-175222A and JP2009-237376A can be referred to. When a cycloolefin-based polymer film is included, it is possible to impart moisture permeability to the polarizing plate. Moisture permeability refers to a property which does not allow passage of water but allows passage of moisture.

The film thickness of the protective film may be 100 μm or smaller, 50 μm or smaller, 30 μm or smaller, 20 μm or smaller, or 10 μm or smaller, and may be 1 μm or larger, 5 μm or larger, or 10 μm or larger.

[Hard Coat Layer]

The polarizing plate may include a hard coat layer. The hard coat layer may be included as an outermost layer of the polarizing plate and is preferably included as the outermost layer on the optical anisotropic layer side when seen from the polarizer.

In the present specification, the hard coat layer refers to a layer that increases the pencil hardness of the polarizing plate when formed. Practically, the pencil hardness (JIS K5400) after the lamination of the hard coat layer is preferably H or higher, more preferably 2 H or higher, and most preferably 3 H or higher. The thickness of the hard coat layer is preferably in a range of 0.4 μm to 35 μm, more preferably in a range of 1 μm to 30 μm, and most preferably in a range of 1.5 μm to 20 μm.

Regarding the specific composition, the description of JP2012-103689A can be referred to.

### EXAMPLES

Hereinafter, the present invention will be more specifically described using examples. The amounts and proportions of materials, reagents, and substances, operations, and the like described in the following examples can be appropriately altered within the purport of the present invention. Therefore, the scope of the present invention is not limited to the following examples.

Meanwhile, in the examples, Re and the slow axis were measured indoors at 23° C. using an AxoScan manufactured by Axometrics, Inc. In a case in which the slow axes in the respective optical anisotropic layers laminated in the polarizing plate or the transfer material were measured, the slow axes were measured after the temporary support and the like were peeled off. In addition, in the polarizing plate or the transfer material including two optical anisotropic layers, the slow axis in the optical anisotropic layer formed as the second layer was measured by separately producing the same phase difference layer as the optical anisotropic layer formed as the first layer, superimposing the phase difference layer in a state of being rotated 90° in a plane, and offsetting the phase difference in the optical anisotropic layer formed as the first layer.

<Production of Support 1 (Cellulose Acetate Film T1)>

The following composition was injected into a mixing tank and was stirred under heating, and individual components were dissolved, thereby preparing a cellulose acetate solution.

Composition of cellulose acetate solution

| | | |
|---|---|---|
| Cellulose acetate having an acetylation degree | 100 | parts by mass |
| in a range of 60.7% to 61.1% | | |
| Triphenyl phosphate (plasticizer) | 7.8 | parts by mass |
| Biphenyl diphenyl phosphate (plasticizer) | 3.9 | parts by mass |
| Methylene chloride (first solvent) | 336 | parts by mass |
| Methanol (second solvent) | 29 | parts by mass |
| 1-Butanol (third solvent) | 11 | parts by mass |

Into a separate mixing tank, the following additive (A) (16 parts by mass), methylene chloride (92 parts by mass), and methanol (8 parts by mass) were injected and were stirred under heating, thereby preparing a solution of the additive (A). A cellulose acetate solution (474 parts by mass) was mixed with the solution of the additive (A) (25 parts by mass), and the components were sufficiently stirred, thereby preparing a dope. The amount of the additive (A) added was 6.0 parts by mass with respect to 100 parts by mass of cellulose acetate.

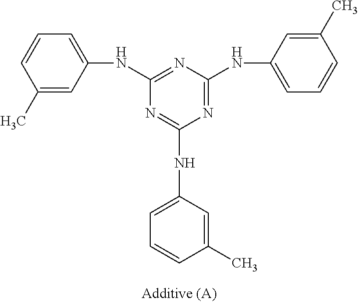 [SMILES: Cc1cccc(Nc2nc(Nc3cccc(C)c3)nc(Nc3cccc(C)c3)n2)c1]

The obtained dope was cast using a band stretching machine. After the temperature of the film surface on the band reached 40° C., the cast dope was dried for one minute using warm air (70° C.), and the film was dried from the band for ten minutes using dried air (140° C.), thereby producing a cellulose acetate film T1 (support 1) having a residual solvent amount of 0.3% by mass.

The obtained long cellulose acetate film T1 had a width of 1490 mm and a thickness of 80 μm. In addition, the in-plane retardation (Re) was 8 nm.

<Production of Transfer Material 1>

(Formation of Alignment Film 1)

An alignment layer coating liquid having the following composition was continuously applied onto the support produced above using a #14 wire bar. The coating liquid was dried using warm air (60° C.) for 60 seconds and further dried using warm air (100° C.) for 120 seconds. The degree of saponification of the modified polyvinyl alcohol used was 96.8%.

The film thickness of the obtained alignment film was 0.5 μm.

Composition of coating liquid of alignment layer 1

| | | |
|---|---|---|
| Modified polyvinyl alcohol (A) | 10 | parts by mass |
| Water | 308 | parts by mass |
| Methanol | 70 | parts by mass |
| Isopropanol | 29 | parts by mass |
| Photopolymerization initiator (ERGACURE2959, | 0.8 | parts by mass |
| manufactured by BASF) | | |

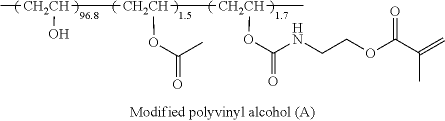

<Production of Transfer Material 1>

An optical anisotropic layer a was produced using the following optical anisotropic layer a-1 and the following optical anisotropic layer a-2. The aperture angle between the slow axes of the obtained optical anisotropic layer a-1 and the obtained optical anisotropic layer a-2 (the difference between the slow axis directions) was 90°.

(Formation of Optical Anisotropic Layer a-1)

A laminate of the support 1 and the alignment layer 1 was produced, and the alignment layer 1 was rubbed. At this time, the longitudinal direction of a long film and the transportation direction were parallel to each other, and the angle formed between the longitudinal direction of the film and the rotational axis of a rubbing roller was set to 90° (clockwise rotation) (when the longitudinal direction of the film was set to 90°, the rotational axis of the rubbing roller was 0°).

A coating liquid of the optical anisotropic layer a-1 including a discotic liquid crystal compound having the following composition was continuously applied to the rubbed surface of the alignment layer 1 using a #5 wire bar. In order to dry the solvent of the coating liquid and align and age the discotic liquid crystal compound, the applied coating liquid film was heated for 90 seconds using warm air (115° C.), subsequently, was heated for 60 seconds using warm air (80° C.), and was irradiated with UV at 80° C., thereby immobilizing the alignment of the liquid crystal compound. The thickness of the obtained optical anisotropic layer was 2.0 μm. It was confirmed that the average inclination angle of the disc surface of the discotic liquid crystal compound with respect to the film surface was 90° and the discotic liquid crystal compound was aligned vertically with respect to the film surface. In addition, the angle of the slow axis was parallel to the rotational axis of the rubbing roller, and was 0° when the longitudinal direction of the film was set to 900 (the width direction of the film was 0°).

Composition of coating liquid of optical anisotropic layer a-1

| | | |
|---|---|---|
| Discotic liquid crystal compound (A) | 80 | parts by mass |
| Discotic liquid crystal compound (B) | 20 | parts by mass |
| Ethylene oxide-modified trimethylol propane | 10 | parts by mass |
| triacrylate (V#360, manufactured by Osaka | | |
| Organic Chemical Industry Ltd.) | | |
| Photopolymerization initiator (IRGACURE907, | 3 | parts by mass |
| manufactured by BASF) | | |
| Pyridinium salt (B) | 0.9 | parts by mass |
| Boric acid-containing compound below | 0.08 | parts by mass |
| Polymer (A) | 1.2 | parts by mass |
| Fluorine-based polymer (FP1) | 0.3 | parts by mass |
| Ethyl methyl ketone | 183 | parts by mass |
| Cyclohexanone | 40 | parts by mass |

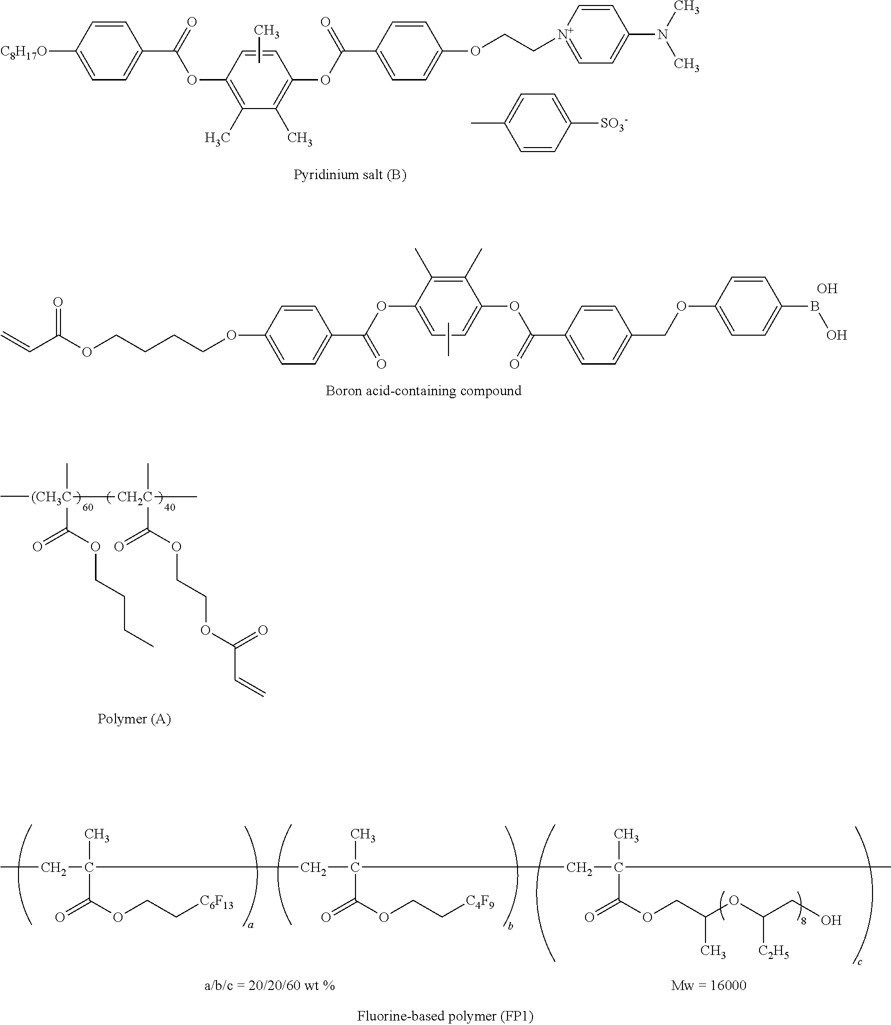

(Formation of Optical Anisotropic Layer a-2)

The produced optical anisotropic layer a-1 was continuously rubbed. At this time, the longitudinal direction of a long film and the transportation direction were parallel to each other, and the angle formed between the longitudinal direction of the film and the rotational axis of a rubbing roller was set to −90° (counterclockwise rotation) (when the longitudinal direction of the film was set to 90°, the rotational axis of the rubbing roller was 180°).

A coating liquid having the following composition was continuously applied to the rubbed optical anisotropic layer a-1 using a #2.2 wire bar. In order to dry the solvent of the coating liquid and align and age the discotic liquid crystal compound, the applied coating liquid film was heated for 60 seconds using warm air (60° C.) and was irradiated with UV at 60° C., thereby immobilizing the alignment of the liquid crystal compound. The thickness of the obtained optical anisotropic layer a-2 was 0.8 μm. A laminate of the optical anisotropic layer a-1 and the optical anisotropic layer a-2 was used as the optical anisotropic layer a. It was confirmed that the average inclination angle of the long axis of the rod-like liquid crystal compound with respect to the film surface was 0° and the liquid crystal compound was aligned horizontally with respect to the film surface. In addition, the angle of the slow axis was orthogonal to the rotational axis of the rubbing roller, and was 75° when the longitudinal direction of the film was set to 90° (the width direction of the film was 0°).

Composition of coating liquid of optical anisotropic layer a-2

| | | |
|---|---|---|
| Polymerizable liquid crystal compound (LC-1) | 80 | parts by mass |
| Polymerizable liquid crystal compound (LC-2) | 20 | parts by mass |
| Photopolymerization initiator (IRGACURE907, | 3 | parts by mass |
| manufactured by BASF) | | |
| Sensitizer (KAYACURE DETX, manufactured by | 1 | part by mass |
| Nippon Kayaku Co., Ltd.) | | |
| Fluorine-based polymer (FP2) | 0.3 | parts by mass |
| Ethyl methyl ketone | 193 | parts by mass |
| Cyclohexanone | 50 | parts by mass |

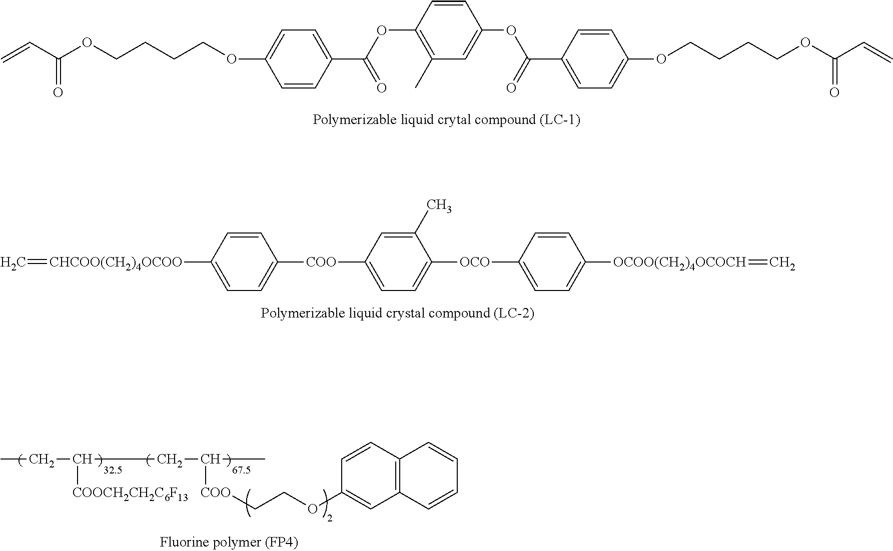

<Production of Transfer Material 2>

A laminate of the support 1 and the alignment layer 1 was produced in the same manner as the production of the transfer material 1, and the alignment layer 1 in the laminate was continuously rubbed. At this time, the longitudinal direction of a long film and the transportation direction were parallel to each other, and the angle formed between the longitudinal direction of the film and the rotational axis of a rubbing roller was set to 45° (clockwise rotation) (when the longitudinal direction of the film was set to 90°, the rotational axis of the rubbing roller was 45°).

(Formation of Optical Anisotropic Layer b-1)

A coating liquid of the optical anisotropic layer b-1 including a discotic liquid crystal compound having the following composition was continuously applied to the rubbed surface of the alignment layer 1 using a #5 wire bar. In order to dry the solvent of the coating liquid and align and age the discotic liquid crystal compound, the applied coating liquid film was heated for 60 seconds using warm air (60° C.), and was irradiated with UV at 60° C., thereby immobilizing the alignment of the liquid crystal compound. The thickness of the obtained optical anisotropic layer was 2.0 μm. In addition, the angle of the slow axis was orthogonal to the rotational axis of the rubbing roller, and was 135° when the longitudinal direction of the film was set to 90° (the width direction of the film was 0°).

Composition of coating liquid of optical anisotropic layer b-1

| | | |
|---|---|---|
| Polymerizable liquid crystal compound (LC-1-1) | 80 | parts by mass |
| Polymerizable liquid crystal compound (LC-2) | 20 | parts by mass |
| Photopolymerization initiator (IRGACURE907, | 3 | parts by mass |
| manufactured by BASF) | | |
| Polymer (A) | 1.5 | parts by mass |
| Fluorine-based polymer (FP1) | 0.3 | parts by mass |
| Ethyl methyl ketone | 183 | parts by mass |
| Cyclohexanone | 40 | parts by mass |

After that, a transfer material 2 including the optical anisotropic layer b-1 (a laminate of the optical anisotropic layer b-1 and the optical anisotropic layer a-2) was produced using the same method as for the production of the optical anisotropic layer a-2 except for the fact that, as the angle of a rubbing treatment on the optical anisotropic layer b-1, the angle formed between the longitudinal direction of the film and the rotational axis of the rubbing roller was set to −45° C. (counterclockwise rotation) (when the longitudinal direction of the film was set to 90°, the rotational axis of the rubbing roller was 135°). The aperture angle between the slow axes of the obtained optical anisotropic layer b-1 and the obtained optical anisotropic layer a-2 was 90°.

<Production of Transfer Materials 3 and 4>

Transfer materials 3 and 4 were respectively produced in the same manner as the transfer materials 1 and 2 except for the fact that the support 1 was changed to PET (thickness: 75 μm) manufactured by Fujifilm Corporation.

Production of Transfer Material 5>

A transfer material 5 was produced in the same manner as the transfer material 4 except for the fact that the support 1 was changed to PET (thickness: 75 μm) manufactured by Fujifilm Corporation, the alignment layer 1 was not provided, and the same rubbing treatment as the rubbing treatment carried out on the alignment layer 1 was carried out on the support PET.

<Production of Transfer Materials 6 and 8>

Transfer materials 6 and 8 were produced in the same manner as the transfer materials 1 and 3 except for the fact that, as the rubbing angle of the optical anisotropic layer a-1, the angle formed between the longitudinal direction of the film and the rotational axis of the rubbing roller was set to 80° C. (clockwise rotation) (when the longitudinal direction of the film was set to 90°, the rotational axis of the rubbing roller was 10°) and, as the robbing angle of the optical anisotropic layer a-2, the angle formed between the longitudinal direction of the film and the rotational axis of the rubbing roller was set to −80° C. (counterclockwise rotation) (when the longitudinal direction of the film was set to 90°, the rotational axis of the rubbing roller was 170°). The aperture angles between the slow axes of the optical anisotropic layer a-1 and the optical anisotropic layer a-2 in the obtained transfer materials 6 and 8 were 70°,

<Production of Transfer Materials 7, 9, and 10>

Transfer materials 7, 9, and 10 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 55° C. (clockwise rotation) (when the longitudinal direction of the film was set to 90°, the rotational axis of the rubbing roller was 35°) and, as the rubbing angle of the optical anisotropic layer a-2, the angle formed between the longitudinal direction of the film and the rotational axis of the rubbing roller was set to −55° C. (counterclockwise rotation) (when the longitudinal direction of the film was set to 90°, the rotational axis of the robbing roller was 145°). The aperture angles between the slow axes of the optical anisotropic layer b-1 and the optical anisotropic layer a-2 in the obtained transfer materials 7, 9, and 10 were 70°.

<Production of Transfer Materials 11 and 13>

Transfer materials 11 and 13 were produced in the same manner as the transfer materials 1 and 3 except for the fact that, as the rubbing angle of the optical anisotropic layer a-1, the angle formed between the longitudinal direction of the film and the rotational axis of the rubbing roller was set to 70° C. (clockwise rotation) (when the longitudinal direction of the film was set to 90°, the rotational axis of the rubbing roller was 20°) and, as the rubbing angle of the optical anisotropic layer a-2, the angle formed between the longitudinal direction of the film and the rotational axis of the rubbing roller was set to −70° C. (counterclockwise rotation) (when the longitudinal direction of the film was set to 90°, the rotational axis of the rubbing roller was 160°). The aperture angles between the slow axes of the optical anisotropic layer a-1 and the optical anisotropic layer a-2 in the obtained transfer materials 11 and 13 were 50°.

<Production of Transfer Materials 12, 14, and 15>

Transfer materials 12, 14, and 15 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 65° C. (clockwise rotation) (when the longitudinal direction of the film was set to 90°, the rotational axis of the rubbing roller was 25°) and, as the rubbing angle of the optical anisotropic layer a-2, the angle formed between the longitudinal direction of the film and the rotational axis of the rubbing roller was set to −65° C. (counterclockwise rotation) (when the longitudinal direction of the film was set to 90°, the rotational axis of the rubbing roller was 155°). The aperture angles between the slow axes of the optical anisotropic layer b-1 and the optical anisotropic layer a-2 in the obtained transfer materials 12, 14, and 15 were 50°.

<Production of Transfer Materials 16 and 18>

Transfer materials 16 and 18 were produced in the same manner as the transfer materials 1 and 3 except for the fact that, as the rubbing angle of the optical anisotropic layer a-1, the angle formed between the longitudinal direction of the film and the rotational axis of the rubbing roller was set to 57.5° C. (clockwise rotation) (when the longitudinal direction of the film was set to 90°, the rotational axis of the rubbing roller was 32.5°) and, as the rubbing angle of the optical anisotropic layer a-2, the angle formed between the longitudinal direction of the film and the rotational axis of the rubbing roller was set to −57.5° C. (counterclockwise rotation) (when the longitudinal direction of the film was set to 90°, the rotational axis of the rubbing roller was 147.5°). The aperture angles between the slow axes of the optical anisotropic layer a-1 and the optical anisotropic layer a-2 in the obtained transfer materials 16 and 18 were 25°.

<Production of Transfer Materials 17, 19, and 20>

Transfer materials 17, 19, and 20 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 77.5° C. (clockwise rotation) (when the longitudinal direction of the film was set to 90°, the rotational axis of the rubbing roller was 12.5°) and, as the rubbing angle of the optical anisotropic layer a-2, the angle formed between the longitudinal direction of the film and the rotational axis of the rubbing roller was set to −77.5° C. (counterclockwise rotation) (when the longitudinal direction of the film was set to 90°, the rotational axis of the rubbing roller was 167.5°). The aperture angles between the slow axes of the optical anisotropic layer b-1 and the optical anisotropic layer a-2 in the obtained transfer materials 17, 19, and 20 were 25°.

<Production of Transfer Materials 21 and 23>

Transfer materials 21 and 23 were produced in the same manner as the transfer materials 1 and 3 except for the fact that, as the rubbing angle of the optical anisotropic layer a-1, the angle formed between the longitudinal direction of the film and the rotational axis of the rubbing roller was set to 50° C. (clockwise rotation) (when the longitudinal direction of the film was set to 90°, the rotational axis of the rubbing roller was 40°) and, as the rubbing angle of the optical anisotropic layer a-2, the angle formed between the longitudinal direction of the film and the rotational axis of the rubbing roller was set to −50° C. (counterclockwise rotation) (when the longitudinal direction of the film was set to 90°, the rotational axis of the rubbing roller was 140°). The aperture angles between the slow axes of the optical anisotropic layer a-1 and the optical anisotropic layer a-2 in the obtained transfer materials 21 and 23 were 100.

<Production of Transfer Materials 22, 24, and 25>

Transfer materials 22, 24, and 25 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 85° C. (clockwise rotation) (when the longitudinal direction of the film was set to 90°, the rotational axis of the rubbing roller was 5°) and, as the rubbing angle of the optical anisotropic layer a-2, the angle formed between the longitudinal direction of the film and the rotational axis of the rubbing roller was set to −85° C. (counterclockwise rotation) (when the longitudinal direction of the film was set to 90°, the rotational axis of the rubbing roller was 175°). The aperture angles between the slow axes of the optical anisotropic layer b-1 and the optical anisotropic layer a-2 in the obtained transfer materials 22, 24, and 25 were 10°.

<Production of Transfer Materials 26 and 28>

Transfer materials 26 and 28 were produced in the same manner as the transfer materials 1 and 3 except for the fact that, as the rubbing angle of the optical anisotropic layer a-1, the angle formed between the longitudinal direction of the film and the rotational axis of the rubbing roller was set to 47.5° C. (clockwise rotation) (when the longitudinal direction of the film was set to 90°, the rotational axis of the rubbing roller was 42.5°) and, as the rubbing angle of the optical anisotropic layer a-2, the angle formed between the longitudinal direction of the film and the rotational axis of the rubbing roller was set to −47.5° C. (counterclockwise rotation) (when the longitudinal direction of the film was set to 90°, the rotational axis of the rubbing roller was 137.50). The aperture angles between the slow axes of the optical anisotropic layer a-1 and the optical anisotropic layer a-2 in the obtained transfer materials 26 and 28 were 50°.

<Production of Transfer Materials 27, 29, and 30>

Transfer materials 27, 29, and 30 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 87.5° C. (clockwise rotation) (when the longitudinal direction of the film was set to 90°, the rotational axis of the rubbing roller was 2.5°) and, as the rubbing angle of the optical anisotropic layer a-2, the angle formed between the longitudinal direction of the film and the rotational axis of the rubbing roller was set to −87.5° C. (counterclockwise rotation) (when the longitudinal direction of the film was set to 90°, the rotational axis of the rubbing roller was 177.5°). The aperture angles between the slow axes of the optical anisotropic layer b-1 and the optical anisotropic layer a-2 in the obtained transfer materials 27, 29, and 30 were 5°.

<Production of Transfer Materials 31 and 33>

Transfer materials 31 and 33 were produced in the same manner as the transfer materials 1 and 3 except for the fact that, as the rubbing angle of the optical anisotropic layer a-1, the angle formed between the longitudinal direction of the film and the rotational axis of the rubbing roller was set to 46.5° C. (clockwise rotation) (when the longitudinal direction of the film was set to 90°, the rotational axis of the rubbing roller was 43.5°) and, as the rubbing angle of the optical anisotropic layer a-2, the angle formed between the longitudinal direction of the film and the rotational axis of the rubbing roller was set to −46.5° C. (counterclockwise rotation) (when the longitudinal direction of the film was set to 90°, the rotational axis of the rubbing roller was 136.5°). The aperture angles between the slow axes of the optical anisotropic layer a-1 and the optical anisotropic layer a-2 in the obtained transfer materials 31 and 33 were 3°.

<Production of Transfer Materials 32, 34, and 35>

Transfer materials 32, 34, and 35 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 88.5° C. (clockwise rotation) (when the longitudinal direction of the film was set to 90°, the rotational axis of the rubbing roller was 1.5°) and, as the rubbing angle of the optical anisotropic layer a-2, the angle formed between the longitudinal direction of the film and the rotational axis of the rubbing roller was set to −88.5° C. (counterclockwise rotation) (when the longitudinal direction of the film was set to 90°, the rotational axis of the rubbing roller was 178.5°). The aperture angles between the slow axes of the optical anisotropic layer b-1 and the optical anisotropic layer a-2 in the obtained transfer materials 32, 34, and 35 were 3°.

### Comparative Examples 1 to 5

### Production of Transfer Materials 36 and 38

Transfer materials 36 and 38 were produced in the same manner as the transfer materials 1 and 3 except for the fact that, as the rubbing angle of the optical anisotropic layer a-1, the angle formed between the longitudinal direction of the film and the rotational axis of the rubbing roller was set to 45° C. (clockwise rotation) (when the longitudinal direction of the film was set to 90°, the rotational axis of the rubbing roller was 45°) and, as the rubbing angle of the optical anisotropic layer a-2, the angle formed between the longitudinal direction of the film and the rotational axis of the rubbing roller was set to −45° C. (counterclockwise rotation) (when the longitudinal direction of the film was set to 90°, the rotational axis of the rubbing roller was 135°). The aperture angles between the slow axes of the optical anisotropic layer a-1 and the optical anisotropic layer a-2 in the obtained transfer materials 36 and 38 were 0°.

<Production of Transfer Materials 37, 39, and 40>

Transfer materials 37, 39, and 40 were produced in the same manner as the transfer materials 2, 4, and 5 except for the fact that, as the rubbing angle of the optical anisotropic layer b-1, the angle formed between the longitudinal direction of the film and the rotational axis of the rubbing roller was set to 90° C. (clockwise rotation) (when the longitudinal direction of the film was set to 90°, the rotational axis of the rubbing roller was 0°) and, as the rubbing angle of the optical anisotropic layer a-2, the angle formed between the longitudinal direction of the film and the rotational axis of the rubbing roller was set to −90° C. (counterclockwise rotation) (when the longitudinal direction of the film was set to 90°, the rotational axis of the rubbing roller was 180°. The aperture angles between the slow axes of the optical anisotropic layer b-1 and the optical anisotropic layer a-2 in the obtained transfer materials 37, 39, and 40 were 0°.

### Comparative Examples 6 and 7

### Production of Transfer Materials 41 and 42

The optical anisotropic layer a-1 and the optical anisotropic layer b-1 were produced and transfer materials 41 and 42 were obtained in the same manner as the transfer materials 3 and 4 except for the fact that the optical anisotropic layers were not laminated.

### Comparative Example 8

### Production of Transfer Material 43

A laminate of the support 1 and the alignment layer 1 was produced in the same manner as the production of the transfer material 1, and the alignment layer 1 in the laminate was rubbed in the same manner as for the transfer material 2. A coating liquid of a cholesteric liquid crystal layer 3 shown in Table 1 was applied to the rubbed surface using a wire bar so that the thickness of the dried film reached 2.0 μm. The coating layer was dried at room temperature for 30 seconds, then, was heated in an atmosphere of 85° C. for two minutes, and then was irradiated at an output of 60% using a fusion D valve (with a lamp of 90 mW/cm) at 30° C. for 6 seconds to 12 seconds, thereby obtaining a liquid crystal layer. The coating liquid of the cholesteric liquid crystal layer 3 was applied onto the liquid crystal layer at room temperature so that the thickness of the dried film reached 0.8 μm, then, the coating layer was dried, heated, and irradiated with UV in the same manner as described above, and a second cholesteric liquid crystal layer was formed, thereby producing a transfer material 43.

Composition of coating liquid of cholesteric liquid crystal layer 3

| | |
|---|---|
| Polymerizable liquid crystal compound (LC-1) | 100 parts by mass |
| Photopolymerization initiator (IRGACURE819,) | 5 parts by mass |
| manufactured by BASF | |
| Alignment controller (FP3) | 0.03 parts by mass |
| Chiral agent (LC-756 manufactured by BASF) | 7 parts by mass |
| Ethyl methyl ketone | appropriately adjusted |
| | depending on film |
| | thickness |

FP3 (compound described in JP2005-99248A)

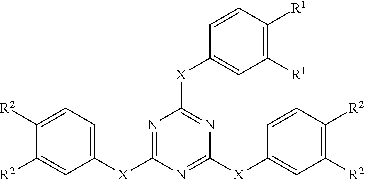

| R¹ | R² | X |
|---|---|---|
| O(CH₂)₂O(CH₂)₂(CF₂)₆F | O(CH₂)₂O(CH₂)₂(CF₂)₆F | NH |

### Comparative Example 9

### Production of Transfer Material 44

A transfer material 44 was produced in the same manner as the transfer materials 43 except for the fact that the alignment layer was not provided.

<Evaluation of Properties of being Peeled Off from Temporary Support>

Each of the transfer materials 1 to 44 was cut into a 200 mm×300 mm size, and the properties of being peeled off from a temporary support obtained by adhering polyester gluing tape “No. 31B” manufactured by Nitto Denko Corporation to a layer having a 200 mm-long side was evaluated using the following standards. The results are shown in Table 1.

A: In all three trials, the full surface of the transfer body can be smoothly peeled off.

B: In two out of three trials, the full surface of the transfer body can be smoothly peeled off.

C: In one out of three trials, the full surface of the transfer body can be smoothly peeled off.

D: In all three trials, the transfer body was scattered in the middle and only approximately half of the transfer body can be peeled off.

E: In all three trials, the transfer body was scattered and cannot be peeled off.

TABLE 1

| | | | | | Angular | |
|---|---|---|---|---|---|---|
| | | | | | difference | Peeling during peeling |
| | | Temporary | Alignment | | between slow | from temporary |
| | | support | layer | Liquid crystal layer | axes | support |
| Example 1 | Transfer | T1 | Present | Optical anisotropic | 90 | A |
| | material 1 | | | layer a | | |
| Example 2 | Transfer | T1 | Present | Optical anisotropic | 90 | A |
| | material 2 | | | layer b | | |
| Example 3 | Transfer | PET | Present | Optical anisotropic | 90 | A |
| | material 3 | | | layer a | | |
| Example 4 | Transfer | PET | Present | Optical anisotropic | 90 | A |
| | material 4 | | | layer b | | |
| Example 5 | Transfer | PET | — | Optical anisotropic | 90 | A |
| | material 5 | | | layer b | | |
| Example 6 | Transfer | T1 | Present | Optical anisotropic | 70 | A |
| | material 6 | | | layer a | | |
| Example 7 | Transfer | T1 | Present | Optical anisotropic | 70 | A |
| | material 7 | | | layer b | | |
| Example 8 | Transfer | PET | Present | Optical anisotropic | 70 | A |
| | material 8 | | | layer a | | |
| Example 9 | Transfer | PET | Present | Optical anisotropic | 70 | A |
| | material 9 | | | layer b | | |
| Example 10 | Transfer | PET | — | Optical anisotropic | 70 | A |
| | material 10 | | | layer b | | |
| Example 11 | Transfer | T1 | Present | Optical anisotropic | 50 | A |
| | material 11 | | | layer a | | |
| Example 12 | Transfer | T1 | Present | Optical anisotropic | 50 | A |
| | material 12 | | | layer b | | |
| Example 13 | Transfer | PET | Present | Optical anisotropic | 50 | A |
| | material 13 | | | layer a | | |
| Example 14 | Transfer | PET | Present | Optical anisotropic | 50 | A |
| | material 14 | | | layer b | | |
| Example 15 | Transfer | PET | — | Optical anisotropic | 50 | A |
| | material 15 | | | layer b | | |
| Example 16 | Transfer | T1 | Present | Optical anisotropic | 25 | A |
| | material 16 | | | layer a | | |
| Example 17 | Transfer | T1 | Present | Optical anisotropic | 25 | A |
| | material 17 | | | layer b | | |
| Example 18 | Transfer | PET | Present | Optical anisotropic | 25 | A |
| | material 18 | | | layer a | | |
| Example 19 | Transfer | PET | Present | Optical anisotropic | 25 | A |
| | material 19 | | | layer b | | |
| Example 20 | Transfer | PET | — | Optical anisotropic | 25 | A |
| | material 20 | | | layer b | | |
| Example 21 | Transfer | T1 | Present | Optical anisotropic | 10 | A |
| | material 21 | | | layer a | | |
| Example 22 | Transfer | T1 | Present | Optical anisotropic | 10 | A |
| | material 22 | | | layer b | | |
| Example 23 | Transfer | PET | Present | Optical anisotropic | 10 | A |
| | material 23 | | | layer a | | |
| Example 24 | Transfer | PET | Present | Optical anisotropic | 10 | A |
| | material 24 | | | layer b | | |
| Example 25 | Transfer | PET | — | Optical anisotropic | 10 | A |
| | material 25 | | | layer b | | |
| Example 26 | Transfer | T1 | Present | Optical anisotropic | 5 | B |
| | material 26 | | | layer a | | |
| Example 27 | Transfer | T1 | Present | Optical anisotropic | 5 | B |
| | material 27 | | | layer b | | |
| Example 28 | Transfer | PET | Present | Optical anisotropic | 5 | B |
| | material 28 | | | layer a | | |
| Example 29 | Transfer | PET | Present | Optical anisotropic | 5 | B |
| | material 29 | | | layer b | | |
| Example 30 | Transfer | PET | — | Optical anisotropic | 5 | B |
| | material 30 | | | layer b | | |
| Example 31 | Transfer | T1 | P VA | Optical anisotropic | 3 | C |
| | material 31 | | | layer a | | |
| Example 32 | Transfer | T1 | PVA | Optical anisotropic | 3 | C |
| | material 32 | | | layer b | | |
| Example 33 | Transfer | PET | PVA | Optical anisotropic | 3 | C |
| | material 33 | | | layer a | | |
| Example 34 | Transfer | PET | PVA | Optical anisotropic | 3 | C |
| | material 34 | | | layer b | | |
| Example 35 | Transfer | PET | — | Optical anisotropic | 3 | C |
| | material 35 | | | layer b | | |
| Comparative | Transfer | T1 | PVA | Optical anisotropic | 0 | D |
| Example 1 | material 36 | | | layer a | | |
| Comparative | Transfer | T1 | PVA | Optical anisctropic | 0 | D |
| Example 2 | material 37 | | | layer b | | |
| Comparative | Transfer | PET | PVA | Optical anisotropic | 0 | D |
| Example 3 | material 38 | | | layer a | | |
| Comparative | Transfer | PET | PVA | Optical anisotropic | 0 | D |
| Example 4 | material 39 | | | layer b | | |
| Comparative | Transfer | PET | — | Optical anisotropic | 0 | D |
| Example 5 | material 40 | | | layer b | | |
| Comparative | Transfer | PET | PVA | Optical anisotropic | — | D |
| Example 6 | material 41 | | | layer a-1 | | |
| Comparative | Transfer | PET | PVA | Optical anisotropic | — | E |
| Example 7 | material 42 | | | layer a-2 | | |
| Comparative | Transfer | PET | PVA | Cholesteric liquid | — | D |
| Example 8 | material 43 | | | crystal layer 1 | | |
| Comparative | Transfer | PET | — | Cholesteric liquid | — | D |
| Example 9 | material 44 | | | crystal layer 1 | | |

<Production of Polarizing Plates 1 to 35>

(Production of Polarizer)

A 80 μm-thick roll-like polyvinyl alcohol film was continuously stretched five times in an iodine aqueous solution and was dried, thereby obtaining a 20 μm-thick polarizing film (polarizer).

(Production of Acrylic Resin T2)

An acrylic resin described below was used. The acrylic resin can be procured from commercially available products.
DIANAL BR88 (trade name), manufactured by Mitsubishi Rayon Co., Ltd. weight-average molecular weight: 1500000 (hereinafter, referred to as the acrylic resin AC-1)

(Ultraviolet Absorbent)

The following ultraviolet absorbent was used.
UV agent 1: Tinuvin 328 (manufactured by BASF)

(Preparation of Dope A)

The following composition was injected into a mixing tank and was stirred under heating, and individual components were dissolved, thereby preparing dope A.

(Composition of dope A)

| | |
|---|---|
| Acrylic resin AC-1 | 100 parts by mass |
| Ultraviolet absorbent UV agent 1 | 2 parts by mass |
| Dichloromethane | 300 parts by mass |
| Methanol | 40 parts by mass |

The prepared dope was continuously cast from a casting die to a 2000 mm-wide stainless steel endless band (casting support) using a band casting device. A macromolecule film was peeled off from the casting support immediately before a timing of moment when the residual solvent amount in the dope reached 40% by mass, was transported without being stretched, and was dried at 130° C. in a drying zone. The film thickness of the obtained acrylic resin sheet T2 was 40 μm.

A corona treatment was carried out on a single surface of the resin sheet T2 obtained as described above, and the corona-treated surface was attached to a single surface of the polarizer using a 3% aqueous solution of PVA (PVA-117H, manufactured by Kuraray Co., Ltd.) as an adhesive.

Each of the transfer materials 1 to 35 was cut in the longitudinal direction into a size of 200 mm×300 mm (300 mm in the longitudinal direction), and the support 1 or the PET was slowly peeled off from the interface with the alignment layer or, in the case of the transfer material not including the alignment layer, the interface with the optical anisotropic layer b-1, thereby obtaining a transfer body. The surface, which was opposite to the surface from which the support 1 or the PET had been peeled off, of the transfer body obtained from each of the transfer materials 1, 3, 6, 8, 11, 13, 16, 18, 21, 23, 26, 28, 31, and 33 was attached to the remaining single surface of the polarizer using a 3% aqueous solution of polyvinyl alcohol (PVA-117H, manufactured by Kuraray Co., Ltd.) as an adhesive so that the absorption axis of the polarizer became parallel to the longitudinal direction, and the surface of the transfer body obtained from each of the transfer materials 2, 4, 5, 7, 9, 10, 12, 14, 15, 17, 19, 20, 22, 24, 25, 27, 29, 30, 32, 34, and 35 was attached to the remaining single surface of the polarizer so that the angle formed between the absorption axis of the polarizer and the longitudinal direction reached 45°. The obtained polarizing plates were respectively used as polarizing plates 1 to 35.

Evaluation of Mounting in Organic EL Panel

A 15EL9500 equipped with an organic EL panel manufactured by LG electronics was disassembled and a circular polarization plate was peeled off. Each of the polarizing plates 1 to 35 was cut into a screen size and was attached to the front panel surface using a gluing agent. At this time, the polarizing plate was attached so that the optical anisotropic layer was placed on the panel surface side and the polarizing film protective film was placed on the viewer side. The obtained organic EL panel was thin, suppressed reflection in the visible light range, and had anti-reflection performance.

### EXPLANATION OF REFERENCES

1: polarizer
2: optical anisotropic layer 1
3: optical anisotropic layer 2
4: protective film
5: hard coat layer
12: alignment layer

What is claimed is:

1. A polarizing plate fabrication method comprising the following (1) to (3):
(1) preparing a transfer material including a temporary support and a transfer body including an optical anisotropic layer 1 and an optical anisotropic layer 2;
(2) peeling the temporary support and separating the temporary support and the transfer body; and
(3) adhering the transfer body to a film including a polarizer,
wherein both the optical anisotropic layer 1 and the optical anisotropic layer 2 are layers formed of a polymerizable composition including a liquid crystal compound applied onto the temporary support, and
the optical anisotropic layer 1 and the optical anisotropic layer 2 both have in-plane retardation, and a difference between slow axis directions in the optical anisotropic layer 1 and the optical anisotropic layer 2 is in a range of 3° to 90°.

2. The fabrication method according to claim 1,
wherein the optical anisotropic layer 2 is a layer formed of a polymerizable composition including a liquid crystal compound directly applied to the optical anisotropic layer 1.

3. The fabrication method according to claim 2,
wherein the optical anisotropic layer 1 is a layer formed of a polymerizable composition including a liquid crystal compound directly applied to the temporary support.

4. The fabrication method according to claim 2,
wherein the optical anisotropic layer 1 is a layer formed of a polymerizable composition including a liquid crystal compound directly applied to an alignment layer on the temporary support.

5. The fabrication method according to claim 1, comprising:
(1), (2), and (3) in this order.

6. The fabrication method according to claim 5,
wherein the transfer body is adhered to the film including a polarizer on a surface obtained by means of the peeling.

7. The fabrication method according to claim 5,
wherein the transfer body is adhered to the film including a polarizer on a surface opposite to a surface obtained by means of the peeling.

8. The fabrication method according to claim 1, comprising:
(1), (3), and (2) in this order,
wherein, in (3), the transfer material is adhered to the film including a polarizer on a surface on a transfer body side with respect to the temporary support.

9. The fabrication method according to claim 1,
wherein the polarizer in the film including a polarizer is directly adhered to the transfer body.

10. The fabrication method according to claim 1,
wherein the polarizer includes modified or unmodified polyvinyl alcohol.

11. The fabrication method according to claim 1,
wherein the transfer body and the film including a polarizer are adhered to each other using an adhesive including a modified or unmodified polyvinyl alcohol.

12. The fabrication method according to claim 1, comprising between (1) and, (2) and (3):
a step of cutting the transfer material to 0.025 m² or smaller.

13. The fabrication method according to claim 1,
wherein the total film thickness of the optical anisotropic layer 1 and the optical anisotropic layer 2 is 4 μm or smaller.

14. The fabrication method according to claim 1,
wherein the total film thickness of the optical anisotropic layer 1 and the optical anisotropic layer 2 is 3 μm or smaller.

15. The fabrication method according to claim 5,
wherein the total film thickness of the optical anisotropic layer 1 and the optical anisotropic layer 2 is 4 μm or smaller.

16. The fabrication method according to claim 5,
wherein the total film thickness of the optical anisotropic layer 1 and the optical anisotropic layer 2 is 3 μm or smaller.

17. The fabrication method according to claim 7,
wherein the total film thickness of the optical anisotropic layer 1 and the optical anisotropic layer 2 is 4 μm or smaller.

18. The fabrication method according to claim 1,
wherein the temporary support includes a polyester.

19. The fabrication method according to claim 18,
wherein the temporary support includes polyethylene terephthalate.

20. The fabrication method according to claim 1, further comprising:
obtaining the transfer material using a method including the following (11) to (14):
(11) applying a polymerizable composition including a liquid crystal compound onto the temporary support;
(12) obtaining the optical anisotropic layer 1 by means of optical irradiation or heating of a coating layer obtained in (11);
(13) applying a polymerizable composition including a liquid crystal compound onto the optical anisotropic layer 1 obtained in (12); and
(14) obtaining the optical anisotropic layer 2 by means of optical irradiation or heating of a coating layer obtained in (13).
